(19) United States
(12) Patent Application Publication
(10) Pub. No.: US 2013/0268847 A1
(43) Pub. Date: Oct. 10, 2013

(54) SYSTEM AND METHOD FOR DISPLAYING PAGES OF E-BOOK

(71) Applicant: SAMSUNG ELECTRONICS CO., LTD., Suwon-si (KR)

(72) Inventors: Youngri KIM, Suwon-si (KR); Sanghyup LEE, Suwon-si (KR); Shinjun LEE, Yongin-si (KR); Juyoun LEE, Seongnam-si (KR)

(73) Assignee: Samsung Electronics Co., Ltd., Suwon-si (KR)

(21) Appl. No.: 13/858,304

(22) Filed: Apr. 8, 2013

(30) Foreign Application Priority Data
Apr. 9, 2012 (KR) 10-2012-0036585

(51) Int. Cl. G06F 3/0488

(52) U.S. Cl. CPC G06F 3/0488
USPC 715/251

(57) ABSTRACT

A system and method that displays pages of an e-book on a display of a mobile device, according to a user's input information related to the pages is provided. The page display method of a mobile device with a touch screen, includes displaying at least one page of an e-book on the touch screen, detecting a touch in a first corner area of one of the at least one displayed page, deforming the first corner area to a second corner area in response to the touch, detecting a first touch moving from the second corner area, and folding the displayed page according to the movement of the first touch.

### PRIORITY

This application claims the benefit under 35 U.S.C. §119(a) of a Korean patent application filed on Apr. 9, 2012 in the Korean Intellectual Property Office and assigned Serial No. 10-2012-0036585, the entire disclosure of which is hereby incorporated by reference.

### BACKGROUND OF THE INVENTION

1. Field of the Invention

The present invention relates to e-book readers. More particularly, the present invention relates to a system and method for displaying pages of an e-book on a display of a mobile device, according to a user's input information related to the pages.

2. Description of the Related Art

An electronic book (e-book) refers to a book-length publication in digital form, including text, images, and the like that can be used as (e.g., read similar to) a printed book. Users can easily read e-books via electronic devices with an e-book reader function, such as smart phones, tablet PCs, and the like anywhere and anytime the users so desire. The convenience and effectiveness of e-books have led to an increase in the number of e-book users.

Mobile devices with an e-book reader function generally display only the pages of an e-book according to a user's input information. For example, the system and method for displaying pages of an e-book according to the related art does not provide the users with the same feeling as operating the pages of a printed book. The system and method for displaying pages of an e-book according to the related art detects a user's input information regarding an action for turning pages of an e-boo, (e.g., an action for pressing a button for the next page), and instantly replaces a current page with the next page. This page replacement is not a process for turning pages; rather the page replacement more closely corresponds to a web browsing operation.

Meanwhile, most mobile devices are equipped with touch screens. The mobile devices equipped with touch screens can detect users' gestures during the display of pages of an e-book, and provide an animation of pages turning in response to the user's detected gesture. Although mobile devices according to the related that are equipped with touch screens may provide users with the same feeling as turning the pages of a printed book, such mobile devices still do not provide a page with an animation that operates as though a page of a printed page is turned in response to a user's gesture of turning the page.

Therefore, a need exists for a system and method for displaying pages of e-book that can provide users who read e-books with the same feeling as reading printed books when they are reading e-books.

The above information is presented as background information only to assist with an understanding of the present disclosure. No determination has been made, and no assertion is made, as to whether any of the above might be applicable as prior art with regard to the present invention.

### SUMMARY OF THE INVENTION

Aspects of the present invention are to address at least the above-mentioned problems and/or disadvantages and to provide at least the advantages described below. Accordingly, an aspect of the present invention is to provide a system and method for displaying pages of e-book that can provide users who read e-books with the same feeling as reading printed books when they are reading e-books.

An aspect of the present invention provides a system and method for displaying pages of e-book that can provide a page of an e-book with an animation that operates as though the page is folded, so that the folded page can be used as a bookmark.

In accordance with an aspect of the present invention, a page display method of a mobile device with a touch screen is provided. The page display method includes displaying at least one page of an e-book on the touch screen, detecting a touch in a first corner area of one of the at least one displayed page, deforming the first corner area to a second corner area in response to the touch, detecting a first touch moving from the second corner area, and folding the displayed page according to the movement of the first touch.

In accordance with another aspect of the present invention, a page display method of a mobile device with a touch screen is provided. The page display method includes displaying at least one page of an e-book and a visual cue in at least one corner area of the displayed page on the touch screen, detecting a touch on the visual cue, detecting a touch moving from the visual cue, and deforming the displayed page according to the movement of the touch.

In accordance with another aspect of the present invention, a page display method of a mobile device with a touch screen is provided. The page display method includes displaying at least one page of an e-book on the touch screen, detecting a touch moving on the displayed at least one page, determining whether the detected touch corresponds to a touch gesture for turning over the displayed page, and turning pages over if the detected touch corresponds to a touch gesture for turning over the displayed page, or folding the page if the detected touch does not correspond to a touch gesture for turning over the page.

In accordance with another aspect of the present invention, a page turning method of a mobile device with a touch screen is provided. The page turning method includes displaying at least one page of an e-book on the touch screen, detecting a touch moving in an edge area of one of the at least one displayed page, and turning pages over, in order, by a preset number, if the touch moves outwards from the edge area. Turning pages over includes stopping turning pages over if a page related to a user's input information is displayed.

In accordance with another aspect of the present invention, a mobile device is provided. The mobile device includes a touch screen for displaying at least one page of an e-book, and a controller for controlling the touch screen. The controller is configured to detect a touch in a first corner area of one of the at least one displayed page, to deform the first corner area to a second corner area in response to the touch, to detect a first touch moving from the second corner area, and to fold the displayed page according to the movement of the first touch.

In accordance with another aspect of the present invention, a non-transitory computer-recordable medium, installed in a mobile device with a touch screen, on which a method for displaying at least one page is implemented is provided. The method includes displaying at least one page of an e-book on the touch screen, detecting a touch in a first corner area of one of the at least one displayed page, deforming the first corner area to a second corner area in response to the touch, detecting a first touch moving from the second corner area, and folding the displayed page according to the movement of the first touch.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 illustrates a schematic block diagram showing a configuration of a mobile device according to an exemplary embodiment of the present invention;

FIGS. 2A to 2D illustrate page meshes according to an exemplary embodiment of the present invention;

FIG. 3 illustrates a flowchart describing a method for folding over a corner of a page of an e-book according to an exemplary embodiment of the present invention;

FIG. 4 illustrates a flowchart describing a method for folding over a corner of a page of an e-book according to an exemplary embodiment of the present invention;

FIG. 5 illustrates a flowchart describing a method for folding over a corner of a page of an e-book according to an exemplary embodiment of the present invention;

FIG. 6 illustrates a flowchart describing a method for opening pages of an e-book with folded portions according to an exemplary embodiment of the present invention;

FIG. 7 illustrates a flowchart describing a method for setting an e-book according to an exemplary embodiment of the present invention;

FIG. 8 illustrates a screen for setting an e-books according to an exemplary embodiment of the present invention;

FIGS. 9A to 9C illustrate screens describing a method for folding a page of an e-book according to an exemplary embodiment of the present invention;

FIG. 10 illustrates a screen describing a method for folding a page of an e-book according to an exemplary embodiment of the present invention;

FIG. 11 illustrates a screen describing a method for folding a page of an e-book according to an exemplary embodiment of the present invention;

FIGS. 12A and 12B illustrate screens describing a method for folding a page of an e-book according to an exemplary embodiment of the present invention;

FIGS. 13A and 13B illustrate screens describing a method for folding a page of an e-book according to an exemplary embodiment of the present invention;

FIGS. 14A and 14B illustrate screens describing a method for folding a page of an e-book according to an exemplary embodiment of the present invention;

FIGS. 15A to 15D illustrate screens describing a method for deforming a folded page according to an exemplary embodiment of the present invention;

FIGS. 16A and 16B illustrate screens describing a method for deforming a folded page according to an exemplary embodiment of the present invention;

FIGS. 17A and 17B illustrate screens describing a method for deforming a folded page according to an exemplary embodiment of the present invention;

FIG. 18 illustrates a screen describing a method for displaying a volume of an e-book, according to an exemplary embodiment of the invention;

FIG. 19 illustrates a screen describing a method for displaying a volume of an e-book, according to an exemplary embodiment of the present invention;

FIG. 20 illustrate a screen describing a method for displaying a volume of an e-book, according to an exemplary embodiment of the present invention;

FIGS. 21A to 21C illustrate screens describing a method for making a memo related to a folded page according to an exemplary embodiment of the present invention;

FIGS. 22A to 22C illustrate screens describing a method for recording a voice memo related to a folded page according to an exemplary embodiment of the present invention;

FIGS. 23A to 23D illustrate screens describing a method for stopping turning pages of an e-book according to an exemplary embodiment of the present invention;

FIGS. 24A and 24B illustrate screens describing a method for stopping turning pages of an e-book according to an exemplary embodiment of the present invention; and

FIGS. 25A to 25C illustrate screens describing a method for stopping turning pages of an e-book according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will understand that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

E-books may be classified, according to fields, as a book, a textbook, a magazine, a newspaper, a comic, a specialty publication, and the like. Each field may be further sub-divided. For example, a book may be classified as a novel, an essay, a poem, and the like. An e-book may include text, images, audio, video, user's input information, and the like. The user's input information refers to information that the user has input or inputs in, for example, a corresponding page of an e-book (e.g., annotations, notes, memos, highlights, images, bookmarks, and the like). The user may input information to the mobile device in a handwriting mode via touch input objects (e.g., fingers, stylus pen, and the like).

The term ‘animation’ refers to a function of a mobile device for making the content, a page, or the like move. In particular, an animation shows the motion of an e-book that operates as though the page is protrudently deformed, turned with protrudent deformation, pressed, folded over, or the like, in response to a user's input information (e.g., touch gesture, and the like).

The term ‘page mesh’ corresponds to geometrical information regarding a page of an e-book. A page mesh includes a number of nodes and links connecting the nodes to each other. The nodes are respectively allocated with masses. The links are also respectively allocated with coefficients of elasticity. Coefficients of elasticity may be set to transfer actual feelings according to the characteristics of paper to users. For example, if a sheet of an e-book is set as thick (e.g., the sheet has a large mass), the sheet may be allocated with a large coefficient of elasticity. Conversely, if a sheet of an e-book is set as thin (e.g., the sheet has a small mass), the sheet may be allocated with a small coefficient of elasticity. Likewise, the nodes located at the inner parts of the pages (e.g., the gutter or spine) may be allocated with relatively large masses. In contrast, the nodes located at the outer parts of the pages (e.g., the edges) have a larger change in position than at the inner parts, and are thus allocated with relatively small masses. It should be understood that all nodes may be allocated with the same mass.

Each node may be subjected to two types of forces. One is an inner force such as an elastic force. The other is an external force such as gravity or human power. Gravity attracts nodes to the ground. The screen displaying a page of an e-book may be defined, in terms of direction, in such a way that the X-Y plane is parallel to the screen surface; the positive Z-axis is perpendicular to the X-Y plane, or located at the user's viewpoint; and the negative Z-axis is thus opposite to the positive Z-axis. The Z-axis is a virtual axis perpendicular to the X-Y plane (e.g., the Z-axis not an actual or tangible axis). Gravity may be applied to all nodes. However, gravity may be applied to corresponding nodes of pages with different values according to the characteristics of paper, thereby transferring the same feeling as the actual paper to users. For example, when a user turns over a sheet of an actual paper book, the sheet may slowly fall if the sheet is thin/light but may fall fast if the sheet is thick/heavy. As another example, when a user turns over a sheet of a book, the sheet may have relatively more resistance (e.g., a larger moment of inertia) associated with turning over the sheet if the sheet is thick/heavy and may have relatively less resistance (e.g., a smaller moment of inertia) associated with turning over the sheet if the sheet is think/light. The differences in the resistance associated with turning over the sheet may be conceptualized or implanted such that the sheet falls slowly if the sheet is thin/light but may fall fast if the sheet is thick/heavy. The following Table 1 shows surface densities according to types of paper.

TABLE 1

| | Weight | |
|---|---|---|
| Paper type | (Paper Density) | |
| Leaflet inserted between the pages of newspaper | 52.3 | g/m² |
| Magazine body paper, advertising bill | 64 | g/m² |
| Ticket, weekly cover, pamphlet | 127.9 | g/m² |
| Fashion magazine cover, business card | 157 | g/m² |
| Sketchbook | 200 | g/m² |
| Printed paper | 75 | g/m² |

As described in Table 1, for example, a pamphlet has a greater paper density than a leaflet. Accordingly, the pamphlet may fall faster than the leaflet.

Human power refers to a user's force applied to a sheet of an e-book when the user turns the sheet over (e.g., a touch gesture applied to a touch screen). An example of the touch gesture is a flick action, a drag action, a press action, or the like. The touch gesture is a vector that is a quantity specified by a magnitude and a direction. When a user applies force to a node, the node moves in the direction of the force. In that case, the other nodes are also subjected to the user applying force to the node because the nodes are connected to each other via links.

Therefore, the nodes are subjected to the net forces acquired by computing the vector sum of the inner forces and the external forces, respectively. If a user applies force to a page displayed on the screen of the mobile device, the controller computes forces acting on the respective nodes based on the user's applied force, and deforms the page mesh based on the computed forces acting on the respective nodes. The user's applied force can be computed in such a way that an acceleration is first acquired via the distance running on the nodes and the velocity and then is multiplied by the mass of a corresponding node. Because the computations of force, acceleration, and velocity are well known, a detailed description thereof is omitted in the following description. Thereafter, the mobile device reflects the deformed page mesh to the page and creates the animation. The creation of an animation based on the user's applied force may be executed via an Application Processor (AP), a Central Processing Unit (CPU), a Graphics Processing Unit (GPU), or the like.

The page display system and method according to exemplary embodiments of the present invention may be applied to various types of electronic devices with an e-book reader function and touch screens. In particular, the page display system and method according to exemplary embodiments of the present invention may be applied to mobile devices. Examples of the mobile device include mobile phones, smart phones, tablet Personal Computers (PCs), hand-held PCs, Portable Multimedia Players (PMPs), e-book readers, Personal Digital Assistants (PDAs), and the like. In the following description, it is assumed that the page display system and method according to exemplary embodiments of the present invention is applied to mobile devices with touch screens.

Exemplary embodiments of the page display system and method according to the present invention are described in detail with reference to the accompanying drawings. Detailed descriptions of well-known functions and structures incorporated herein may be omitted to avoid obscuring the subject matter of the invention.

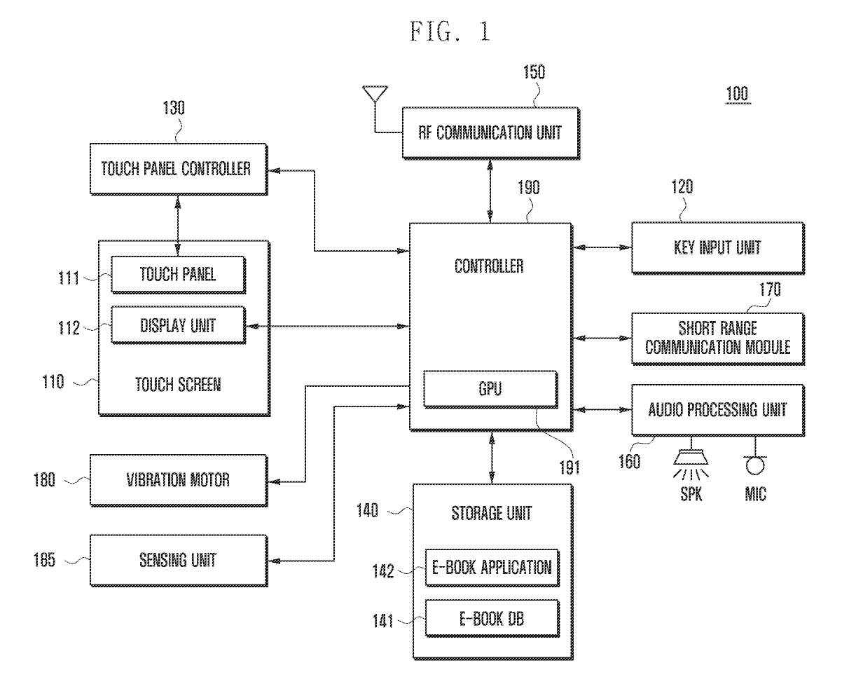

FIG. 1 illustrates a schematic block diagram showing a configuration of a mobile device according to an exemplary embodiment of the present invention.

Referring to FIG. 1, the mobile device 100 includes a touch screen 110, a key input unit 120, a touch panel controller 130, a storage unit 140, an Radio Frequency (RF) communication unit 150, an audio processing unit 160, a Speaker (SPK), a Microphone (MIC), a short-range communication module 170, a vibration motor 180, a sensing unit 185, and a controller 190.

The touch screen 110 includes a touch panel 111 and a display unit 112.

The touch panel 111 may be placed on the display unit 112. The touch panel 111 creates signals according to the user's touch events and transfers the signals to the controller 190. The touch panel 111 may be implemented with an add-on type of touch panel placed on the display unit, an on-cell type or in-cell type of touch panel inserted in the display unit, or the like. The controller 190 identifies touch gestures according to the signals transferred from the touch screen 110, and controls the components in the mobile device. User's actions with respect to the touch screen 110 are classified into touches and touch gestures. Examples of the touch gestures include a tap, a double tap, a long tap, a drag, a drag and drop, a flick, a press, and the like. ‘Touch’ refers to a gesture that contacts one point on the touch screen by using objects (e.g., fingers, stylus pen, and the like). ‘Tap’ refers to a gesture that strikes gently on one point on the touch screen via objects (e.g., fingers, stylus pen, and the like), i.e., a touch and touch-off gesture or a drop gesture. ‘Double tap’ refers to a gesture that strikes gently, successively, twice, one point on the touch screen by using objects (e.g., fingers, stylus pen, and the like). ‘Long tap’ refers to a gesture by which a user contacts one point on the touch screen for longer than the ‘tap’ gesture and then releases the touch. ‘Drag’ refers to a gesture by which a user touches one point on the touch screen and then moves to another location without removing the touch. ‘Drag and drop’ refers to a gesture by which a drag gesture is performed and then releases the touch (touch off) from the touch screen. ‘Flick’ refers to a gesture by which a user brushes lightly or moves faster than the ‘drag’ gesture on the touch panel by using objects (e.g., fingers, stylus pen, and the like) and then releases the touch therefrom. ‘Press’ refers to a gesture by which a user contacts and presses one point on the touch screen by using objects (e.g., fingers, stylus pen, and the like). For example, ‘touch’ means a state by which an object (finger or stylus pen, and the like) is contacting the touch screen, and ‘touch gesture’ means a successive motion on the touch screen from a touch-on gesture until a touch-off gesture. The touch panel 111 includes pressure sensors. The touch panel 111 detects pressure on a touched point and transfer it to the controller 190. The controller 190 distinguishes between a touch and a press via the detected pressure.

The touch panel 111 may be implemented with various types of panels, such as a resistive type, a capacitive type, an electromagnetic induction type, and the like.

The display unit 112 converts video data from the controller 190 into analog data and displays the analog data, under the control of the controller 190. The display unit 112 displays a variety of screens according to the operations of the mobile device (e.g., a lock screen, a home screen, an application execution screen, menu screens, a keypad screen, a message writing screen, an Internet screen, and the like). A lock screen refers to a screen with a lock pattern, for example, displayed when the display unit 112 is turned on. In that case, when a touch event for unlocking the lock occurs on the lock screen, the controller 190 controls the display unit 112 to display a home screen or an application execution screen. A home screen refers to a screen showing a number of icons corresponding to application programs. When the user selects an icon corresponding to an application program (e.g., an e-book application), the controller 190 executes the application program and controls the display unit 112 to display the application executed screen.

The display unit 112 displays an animation under the control of the controller 190 (e.g., an animation that operates as though a page is turned over or a corner of the page is folded over). The animations of pages turning may be displayed differently depending on the thickness of a sheet, a location at which a touch is made on the page, the movement distance of a touch gesture, the movement direction of a touch gesture, the speed of a touch gesture, and the like. In addition, the animations of a corner of a page being folded may be displayed differently depending on the movement distance, movement direction, or speed of a touch gesture from the corner area of the page, and the like. The corner area refers to an area within a radius of 1 cm from a corner point of a page.

The display unit 112 may be implemented with a flat display panel, such as a Liquid Crystal Display (LCD), Organic Light Emitting Diodes (OLEDs), Active Matrix Organic Light Emitting Diodes (AMOLEDs), or the like.

The key input unit 120 includes a number of input keys and function keys that receive numbers and letters and set a variety of functions in the mobile device. The function keys include direction keys, side keys, shortcut keys, and the like, which are set to perform specific functions. The key input unit 120 creates key signals, related to a user's settings and function controls of the mobile device 100, and transfers the signals to the controller 190. Examples of the key signals include a signal for turning on/off the mobile device 100, a signal for adjusting the audio volume, a signal for turning on/off the screen, and the like. The controller 190 controls corresponding components according to the key signals. The key input unit 120 may be implemented with a QWERTY keypad, a 3×4 keypad, a 4×3 keypad, and the like, which includes a number of keys. In particular, if the mobile device 100 is designed to include a full touch screen, the key input unit 120 may be implemented with one or more side keys for turning on/off the screen or the mobile device 100, which are installed to the side of the case of the mobile device 100.

The touch panel controller 130 receives signals corresponding to touch events from the touch panel 111, performs AD conversion to convert the received signal to digital signals, and transfers the signals to the controller 190. The controller 190 detects touch gestures via the signal from the touch panel controller 130. For example, the controller detects a location at which a touch is made on the page, the movement distance of a touch gesture, the movement direction of a touch gesture, the speed of a touch gesture, the pressure of a touch, and the like.

The storage unit 140 stores an Operating System (OS) of the mobile device and application programs according to exemplary embodiments of the present invention. The storage unit 140 also stores data. The storage unit 140 includes a program storage area and a data storage area.

The data storage area stores data that is created when the mobile device 100 is used or data that is downloaded from the external system (e.g., e-books, contacts, images, document files, videos, messages, emails, music files, audio data corresponding to sound effects, and the like). The data storage area also stores screen data to be displayed via the display unit 112. For example, a menu screen may include a key for altering screens (e.g., a return key for returning to the previous screen, and the like), a key for controlling a currently executed application, and the like. The data storage area temporarily stores data via a copying and pasting command (e.g., data copied from messages, photographs, web pages, documents, and the like). The data storage area also store values for setting the functions of the mobile device (e.g., the level of screen brightness, a determination as to whether to operate a vibration when a touch is generated, a determination as to whether the screen is automatically rotated, and the like). In an exemplary embodiment of the present invention, the data storage area stores a database 141 with a number of e-books. The data storage area also stores a reading history regarding the respective e-books. Reading history may include the date of storing e-books, the read number of an e-book, the page read, the date read, the page to be read, the user's input information, and/or the like. User's input information may be displayed on a page when the page or the e-book is displayed (opened).

The program storage area stores an Operating System (OS) for booting and controlling the entire operation of the mobile device, and a number of application programs. The program storage area stores a web browser for accessing the Internet, an MP3 player application for playing back audio files, a camera application for taking photographs and videos and displaying and storing them, and the like. The program storage area stores an e-book application 142 for displaying e-books stored in the e-book DB 141.

The RF communication unit 150 performs a voice/video call, data communication, and the like, under the control of the controller 190. To this end, the RF communication unit 150 includes an RF transmitter for up-converting the frequency of signals to be transmitted and amplifying the signals and an RF receiver for low-noise amplifying received RF signals and down-converting the frequency of the received RF signals. The RF communication unit 150 includes a mobile communication module (e.g., a 3-Generation (3G) mobile communication module, 3.5G, 4G, and the like), a digital broadcasting module (e.g., a DMB module), and the like.

The audio processing unit 160 performs Digital-to-Analog (DA) conversion from audio data output from the controller 190, e.g., such as voice data, and the like, to audible signals and transfers them to a speaker (SPK). The audio processing unit 160 also performs Analog-to-Digital (AD) conversion from audio signals, received via a microphone (MIC) (e.g., voices), to audio data and transfers the audio data to the controller 190. In particular, the audio processing unit 160 outputs a sound effect of a page flipping via the speaker under the control of the controller 190. The page-flipping sound effects may differ from each other, according to the thickness of a sheet, a location at which a touch is made on the page, the movement distance of a touch gesture, the movement direction of a touch gesture, the speed of a touch gesture, and the like.

The short-range communication module 170 allows the mobile device 100 to communicate with external systems in wired or wireless mode. The short-range communication module 170 may be implemented with a module according to Zigbee, Wi-Fi, Bluetooth, or the like. In particular, the short-range communication module 170 receives e-books from external systems and transfers the e-books to the storage unit 150 under the control of the controller 190.

The vibration motor 180 is operated under the control of the controller 190. The vibration motor 180 provides haptic feedback. For example, the controller 190 operates the vibration motor 180 to provide one or more items of feedback on page turning according to the movement of a user's touch gesture. The feedback by the vibration motor 180 may differ according to the material of a sheet, the thickness of a sheet, and the like. For example, if pages of magazines made of a stiff material are turned, the vibration motor 180 provides a relatively high level of vibration. If pages of newspapers made of a thin material are turned, the vibration motor 180 provides a relatively low level of vibration.

The sensing unit 185 detects signals related to changes in tilt, illuminance, and acceleration of the mobile device 100, and transfers the signals to the controller 190. The sensing unit 185 detects changes in the state of the mobile device 100, creates the signals, and transfers the signals to the controller 190. The sensing unit 185 may include various types of sensors. In that case, the controller 190 supplies one or more sensors with electric power when the mobile device 100 is turned on (or according to the user's settings), and detects the change in states of the mobile device 100 via the operated sensors. In an exemplary embodiment of the present invention, the sensing unit 185 is always enabled to detect the changes in states, or tilt, of the mobile device 100. Alternatively, the sensing unit 185 may be enabled according to a user's setting or a user's request.

The sensing unit 185 may be implemented with one or more sensing devices if the sensing devices can detect the change in states of the mobile device 100. Examples of the sensing devices are an acceleration sensor, a gyro sensor, a luminance sensor, a proximity sensor, a pressure sensor, a noise sensor (e.g., a microphone), a video sensor (e.g., a camera module), a timer, and the like. The sensing unit 185 may be implemented with one chip with which a number of sensors are integrated. Alternatively, the sensing unit 185 may be implemented with a number of sensors that are formed as chips respectively. For example, the controller 190 may detect the current state of the mobile device 100, via information regarding the tilt detected by a motion sensor (e.g., values detected with respect to X-, Y-, and Z-axes).

The sensing unit 185 measures the acceleration of the mobile device 100, creates the electrical signal, and transfers the electrical signal to the controller 190. For example, if the sensing unit 185 corresponds to (or includes) a three-axis acceleration sensor, the sensing unit can measure the acceleration of gravity with respect to X-, Y- and Z-axes. The sensing unit 185 can measure a net acceleration from the vector sum of the acceleration of motion of the mobile device 100 and the acceleration of gravity. If the mobile device 100 does not move, the sensing unit 185 can measure only the acceleration of gravity. In an exemplary embodiment of the present invention, it is assumed that the direction of the acceleration of gravity is positive if the front side of the mobile device 100 faces upward and negative if the back side faces upward. If the mobile device 100 is placed on a horizontal surface of an object so that the back side faces the surface, the sensing unit 185 measures the acceleration of gravity as 0 m/sec² with respect to X- and Y-axis components and a positive value (e.g., 9.8 m/sec²) with respect to Z-axis component. In contrast, if the mobile device 100 is placed on a horizontal surface of an object so that the front side faces the surface, the sensing unit 185 measures the acceleration of gravity as 0 m/sec² with respect to X- and Y-axis components and a negative value (e.g., −9.8 m/sec²) with respect to Z-axis component.

If the mobile device 100 is tilted because the user holds the mobile device 100 with his/her one hand, the sensing unit 185 can measure the acceleration of gravity when one or more axes components are not 0 m/sec². In that case, the square root of the sum of the squares of three axes components (i.e., the magnitude of the vector sum of the three axes components), may be a certain value (e.g., 9.8 m/sec²). The sensing unit 185 also detects accelerations with respect to X-, Y-, and Z-axis directions. It should be understood that the axes and the accelerations of gravity corresponding to the axes may differ from each other, respectively, according to the locations at which the sensing unit 185 is attached.

The controller 190 controls the entire operation of the mobile device 100 and the signals flowing among the components therein. The controller 190 processes data. The controller 190 also controls the electric power supplied to the components from the battery. The controller 190 executes the application programs stored in the program storage area. The controller 190 deforms pages in response to a touch gesture (e.g., a drag, a flick, and the like). The controller deforms a page in response to a touch gesture or information regarding how much the mobile device is tilted. To this end, the controller 190 includes a Graphics Processing Unit (GPU) 191. The GPU 191 deforms a page mesh in response to a touch gesture and creates an animation of the page based on the deformed page mesh. The GPU 191 receives information regarding a touch gesture from the touch panel controller 130 and deforms a page mesh based on the received information. If the user applies force to a page, the GPU 191 deforms a page mesh according to the applied force. If the user's applied force is removed (e.g., if the user removes his/her touch after performing a drag action), the GPU 191 restores the deformed page mesh to the original one. For example, the deformed page mesh is restored to the original state by the elastic forces of the links and the forces of gravity applied to the respective nodes. The GPU 191 receives pages from the storage unit 140. The GPU 191 reflects information regarding deformation of a page mesh to a page transmitted from the storage unit 140, and creates the animation. The information regarding deformation of a page mesh includes coordinates (x, y, z) of respective nodes forming the page mesh. The GPU 191 controls the display unit 112 to display animations.

If the controller 190 measures the accelerations of gravity transferred from the sensing unit 185 via one or more axis components, the controller 190 can calculate a tilt of the mobile device 100 via the accelerations with respect to the respective axes. The acquired tilt may include a roll angle Φ, a pitch angle θ and a yaw angle ψ. The roll angle Φ, pitch angle θ and yaw angle ψ are rotational angles with respect to X-, Y- and Z-axes, respectively. If the X- and Y-axis components of the acceleration of gravity transferred from the sensing unit 185 are 0 m/sec² and the Z-axis component is 9.8 m/sec², the tilt (Φ, θ, ψ) of the mobile device 100 is (0, 0, 0). As such, the method according to exemplary embodiments of the present invention can calculate any tilts of the mobile device 100. The controller 190 may calculate the tilt of mobile device 100 via a variety of algorithms (e.g., a position computational algorithm using the Euler angles or an extended Kalman filter, an acceleration estimation switching algorithm, and the like). The measurement of the tilt of the mobile device 100 via an accelerometer may be implemented with a variety of methods.

The controller 190 deforms a page mesh in response to the change in tilt of the mobile device 100 and reflects the deformation of the page mesh to the page, thereby creating the animation of a page. For example, the controller 190 operatively changes characteristics (properties) of the page (or e-book) based on the deformation of the page mesh resulting from the change in tilt of the mobile device 100. The controller 190 detects a tilt of the mobile device 100, calculates the deformation degree of a page based on the detected tilt, and creates and displays an animation corresponding to the calculation. For example, if the mobile device 100 is tilted at a tilt (0, 0, 60), operates in a landscape mode, as a display mode, where two pages are displayed on the screen, side by side, and has 200 pages to be turned over, as the number of remaining pages, displayed on the right part of the screen, the controller 190 may create and display an animation of turning over 100 pages to the left part of the screen. A page turning mode includes a normal mode, a gradient mode, and a merge mode. A page turning mode may be set according to a user's request. If the user sets the page turning mode to a normal mode, the GPU 191 creates an animation in response to the detected touch gesture. If the user sets the page turning mode to a gradient mode, the GPU 191 creates an animation by using a calculated tilt. Likewise, if the user sets the page turning mode to a merge mode, the GPU 191 creates an animation by using a touch gesture and a calculated tilt. The properties (e.g., thickness, weight, material, and the like) set for pages may be taken into account in deforming a page with respect to the respective modes described above. Alternatively, the properties set for pages may not be taken into account in deforming a page. Animations may be created by both or either of a GPU and an Application Processor. The AP may be a System on Chip (SoC) that integrates a CPU and a GPU into a single chip. Alternatively, the AP may be formed in such a way that a CPU and a GPU are packaged in multi-layers.

With the convergence of digital devices, there may be many digital devices and modifications thereof, not listed herein, and it will be appreciated that such digital devices and/or modifications thereof can also be included in the mobile device. For example, the mobile device may further include a GPS module, a camera module, and the like. Also, it will be appreciated that, according to the purposes, the mobile device may be implemented by omitting a particular element from the configuration shown in FIG. 1 or replacing such an element with other elements.

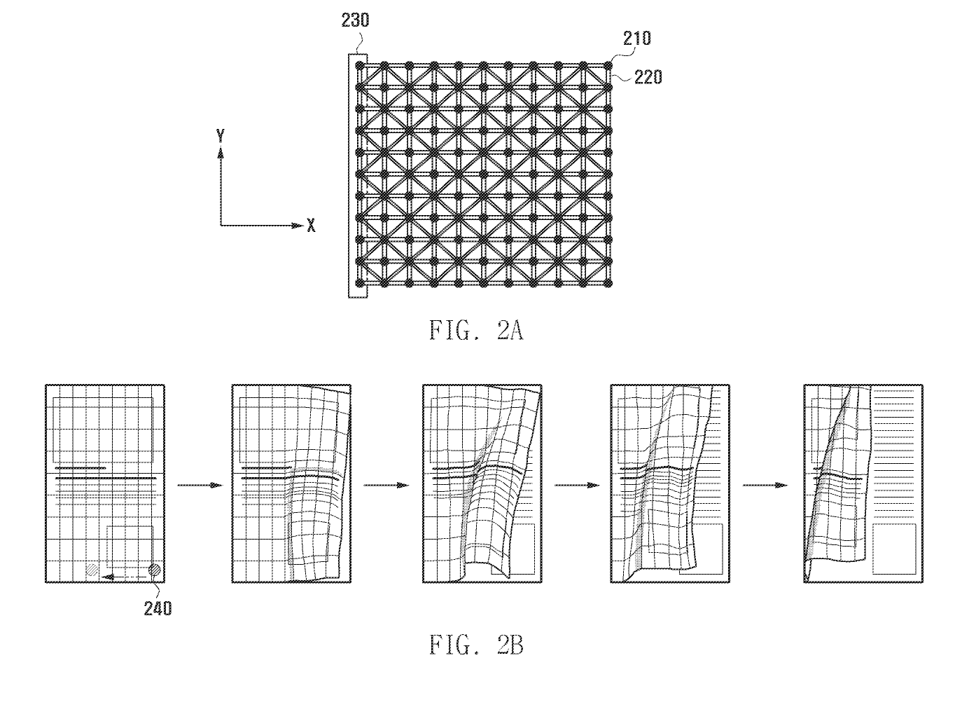

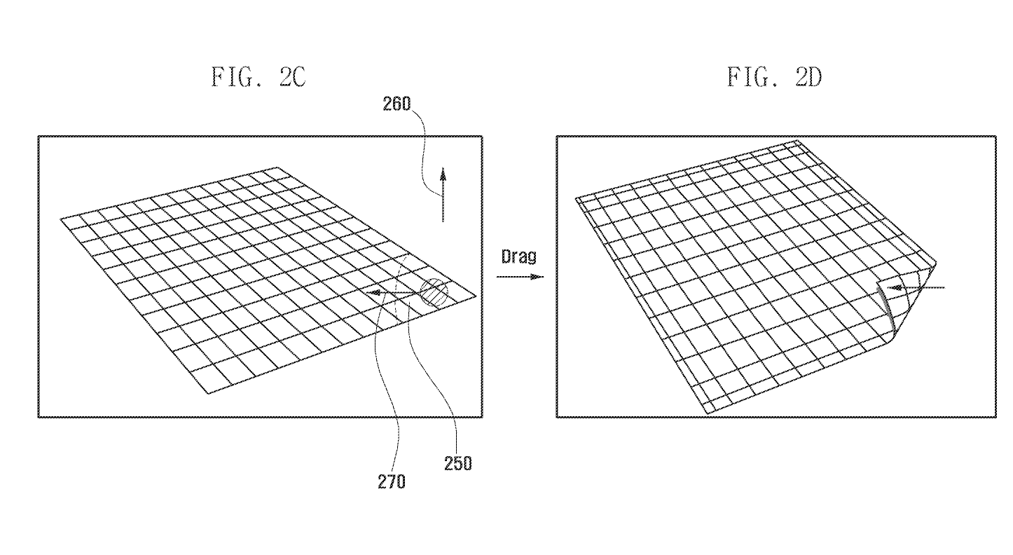

FIGS. 2A to 2D illustrate page meshes according to an exemplary embodiment of the present invention.

Referring to FIG. 2A, the controller 190, or the GPU 191, forms a page mesh. A page mesh includes a number of nodes 210 and a number of links 220 connecting the nodes. For the sake of a convenient description, reference numbers 210 and 220 represent a node and a link respectively. The nodes are arrayed in a matrix form and may be represented via x and y coordinates. As described above, the nodes are allocated with masses respectively, and the links (serving as springs) are also allocated with the coefficients of elasticity respectively. The nodes arrayed close to and along the gutter 230 of an e-book are allocated with a larger mass by rows than those arrayed close to and along the side edge. Therefore, the closer to the side edge the lighter the movement of the nodes. For example, the closer to the side edge the more sensitive the nodes are according to a touch gesture. The nodes located at the gutter 230 are fixed (e.g., do not move) while the other nodes on a page are moved when the page is turned over. In another exemplary embodiment of the present invention, all nodes may be allocated with the same mass. In that case, the motion of a page mesh is heavier than that of the page mesh in the previous exemplary embodiment of the present invention. Therefore, the deformation degrees of the pages differ from each other according to the properties (e.g., thickness, weight, materials, and the like) set to corresponding pages. In addition, the deformation degrees of the pages differ from each other according to the calculated tilts.

If a user applies force, i.e., a touch gesture, to a page, the controller 190, i.e., the GPU 191, detects the touch gesture, deforms a page mesh in response to the detected touch gesture, and creates an animation of the page by reflecting the deformed page mesh to the page. As shown in FIG. 2B, if the user touches a spot 240 at the bottom right of a page via an object (e.g., the finger, a stylus pen, and the like), the controller 190 detects the node touched by the object. After that, if the user moves the object from the spot 240 at the bottom right to the left, the controller 190 moves the touched node (hereinafter called ‘target node’) on the X-Y plane in the left direction according to the movement of the object. In that case, the target node is moved in the direction perpendicular to the direction of the force of gravity. Because the nodes of the gutter 230 are fixed to the spine and the other nodes can be moved according to an external force, if a user touches and moves a page of an e-book, the page mesh is protrudently deformed as though the user presses and pushes a page of a printed book to turn the page over. Referring to FIGS. 2C and 2D, if a user applies a long touch or press gesture (for a period of time, e.g., greater than 1 second) to a corner area 250 of a page via an object (e.g., the finger, a stylus pen, and the like), the controller 190 detects the gesture and moves the target nodes corresponding to the detected gesture in the direction 260 opposite to the direction of gravity. In the following description, it is assumed that the long press gesture includes the concept of the long touch as well. For example, a long press gesture refers to a touch gesture by which a touch or press action does not move for a preset period of time (e.g., 2 seconds) at a position at which the touch or press action was made. After that, if the user moves the object in the diagonal direction 270 from the corner area, the controller 190 moves the target nodes in the same direction. This creates a folded corner area of a page as shown in FIG. 2D.

The controller 190 calculates the displacement of the target node moving. The displacement is a vector. The magnitude of the displacement includes at least one of the current locations of the target node, the distance that target node moved, and the speed of the target node, or the combination thereof. The controller 190 deforms a page mesh according to the calculated displacement. For example, as shown in FIG. 2B, the controller 190 protrudently deforms the page mesh. Likewise, as shown in FIGS. 2C and 2D, the controller 190 deforms the page mesh as the corner area is folded. The controller 190 creates an animation of the page by reflecting the deformed page mesh to the page. The deformed portion (i.e., the folded corner area) may have the shadow thereunder.

The controller 190 can calculate the magnitudes of the forces applied to the respective nodes by using the calculated displacements. The forces are vectors. The force refers to a net force acquired by computing the vector sum of an elastic force, the force of gravity and a user's applied force. If the page turning mode is set as a gradient mode or a merge mode, the force may further include the tilt components. The controller 190 calculates locations of respective nodes by using the calculated forces. Thereafter, the controller 190 creates animations of pages by using the calculated locations, as shown in FIGS. 2A to 2D.

As described above referring to FIGS. 2A to 2D, page meshes are deformed as though paper pages are turned over according to a touch point, the movement direction of a touch, and the speed of a touch, and the like. Therefore, the users who turn over pages of an e-book via the mobile device may experience the same feeling as turning over pages of a paper book.

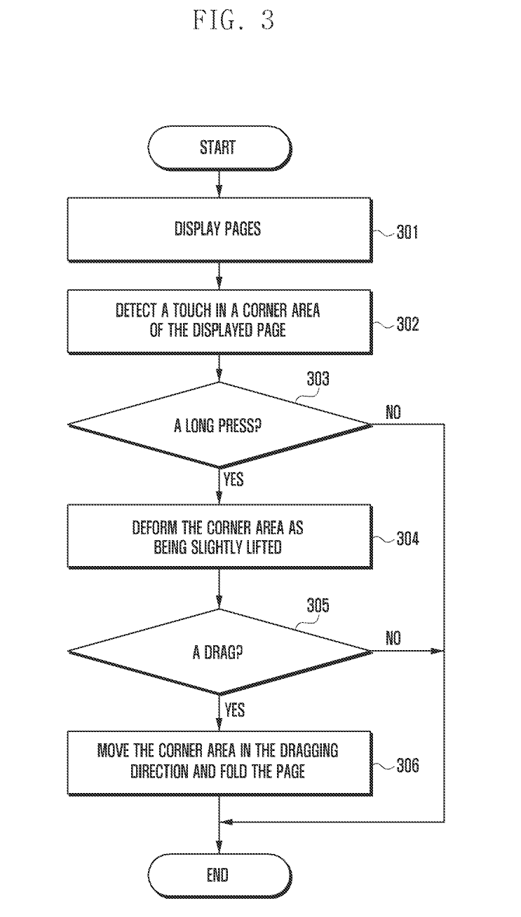

FIG. 3 illustrates a flowchart describing a method for folding over a corner of a page of an e-book according to an exemplary embodiment of the present invention.

Referring to FIG. 3, the controller 190 operates in idle mode. During the idle mode, the controller 190 controls the display unit 112 to display a home screen including an icon for executing an e-book application, for example. When the controller 190 detects a touch gesture to execute an e-book application, the controller 190 executes the application and displays a bookcase or a page of an e-book that has been executed on the touch screen 110.

The controller 190 loads pages of an e-book from the e-book DB 141 and displays the page(s) on the screen in step 301. If the controller 190 executes an e-book for the first time, the controller 190 may display the contents or the first page on the display unit 112. Alternatively, if the controller 190 executes an e-book that the user has read (or partially read), the controller 190 may display the most recently stored page (i.e., the user's most recently read page) on the display unit 112. The controller 190 protrudently displays pages of the e-book on the display unit 112 to resemble pages of a paper book open on a desk. Alternatively, the controller 190 may evenly display pages of the e-book on the display unit 112. The option as to whether pages are protrudently or evenly displayed may be set in the setting mode of the mobile device 100 according to a user's settings. The controller 190 displays the edge of an e-book, showing the volume (thickness). For example, the controller 190 displays the edge (fore edge) of an e-book, showing the volume (thickness) proportional to that of the remaining pages to be read with respect to the currently displayed page. For example, if an e-book has a total of 100 pages and is currently displaying Page 21, then the remaining pages to be read corresponds to 80 pages. In that case, the controller 190 controls the display unit 112 to display the edge with a thickness corresponding to the remaining 80 pages. If there are 20 pages remaining, the controller 190 controls the display unit 112 to display the edge with a thickness corresponding to the remaining 20 pages. The controller 190 may display the edge of an e-book, showing the thicknesses by a unit of preset pages. For example, if a unit of preset pages is 10, the controller 190 displays the edge of an e-book so that the remaining pages are in the same thickness while turning pages from Page 1 to 10. Thereafter, if the e-book is turned to Page 11, the controller 190 displays the edge so that the remaining page is one level thinner than the previous remaining page (Pages 1 to 10). The unit of pages may be set by the user. Alternatively, the controller 190 also displays the volume of an e-book, in proportion to the thickness of each page (sheet). For example, referring to Table 1, although a sketch book and a book of printed paper have the same number of pages, the sketch book is thicker in volume than the book of printed paper.

The controller 190 detects a touch in a corner area of a page in step 302. The corner area refers to an area within a radius of 1 cm from a corner point of a page. The radius for the corner area may be set via the settings of the mobile device 100. The controller 190 acquires a period of time of the touch by detecting how long the touch contacts the corner area and determines whether the detected touch is a long press gesture, based on the contact time period of the touch in step 303. For example, a long press gesture may refer to a touch gesture that contacts a position greater than 1 second. A threshold value for determining whether the detected touch is a long press gesture may be set via the user of the mobile device 100, the manufacturers of the mobile device, or the application associated therewith.

If the controller 190 ascertains that a long press gesture is detected in the corner area at steps 302 and 303, the controller 190 deforms the corner area of the page as being slightly lifted, for example, and displays the deformed corner area of the page on the display unit 112 in step 304. In an exemplary embodiment of the present invention, types of display modes for a screen are divided into landscape mode and portrait mode. The mobile device 100 displays two pages side by side in landscape mode and one page in portrait mode. It should be understood that exemplary embodiments of the present invention are not limited by the types of display modes. For example, exemplary embodiments of the present invention may be modified in such a way that one page can be displayed in landscape mode. Alternatively, exemplary embodiments of the present invention may also be modified in such a way that two pages can be arrayed and displayed on the top and bottom in portrait mode. In addition, the number of pages displayed may be three or more. As described above, the corner area of the page may be deformed as being slightly lifted via a long press gesture. For example, if one page is displayed on the screen, all the corner areas may deformed as being slightly lifted. If two pages of an e-book are displayed side by side on the screen, the top and bottom left corner areas of the page on the left part of the screen and the top and bottom right corner areas of the page on the right part of the screen are deformed as being slightly lifted. The exemplary embodiment of the present invention may be further implemented in such a way as to provide a variety of items of feedback (e.g., an audio type of feedback such as sound effects), a haptic type of feedback (e.g., vibration), and the like, at step 304.

The controller 190 determines whether a touch action (e.g., a drag, a flick, and the like) moves from the deformed corner area in step 305. If the controller 190 detects a touch action (e.g., a drag) moving from the deformed corner area at step 305, the controller 190 moves the deformed corner area in the dragging direction, folds the deformed corner area over, and displays the deformed corner area on the display unit 112 in step 306. The larger the drag movement distance the larger the folded corner area. In addition, the corner area may be deformed, in various shapes (e.g., a triangle, and the like) according to the direction of the drag action. In addition, the corner area may be folded, in various shapes, according to the speed of the drag action. The controller 190 folds the corner area of a page according to information regarding the detected drag action (e.g., the direction, the movement distance, the speed, and the like). For example, the shapes of folded corner areas may differ from each other according to the direction, the movement distance, and the speed of a detected drag action. In addition to the information, the controller 190 may also fold a corner area of a page, considering the page feature or characteristics (e.g., the thickness, weight, material, and the like). Exemplary embodiments of the present invention may be further implemented in such a way as to provide a variety of feedback (e.g., an audio type of feedback such as sound effects), a haptic type of feedback (e.g., vibration), and the like, at step 306. If a touch gesture is removed from a page with a folded corner area, the page may retain the folded corner area while the page is turned over. Information regarding a page with a folded corner area (e.g., page number) is stored, as a user's input information, in the storage unit 140, and used as a bookmark later.

In contrast, if the controller 190 does not detect a corresponding action at steps 303 and 305, the controller 190 terminates the procedure.

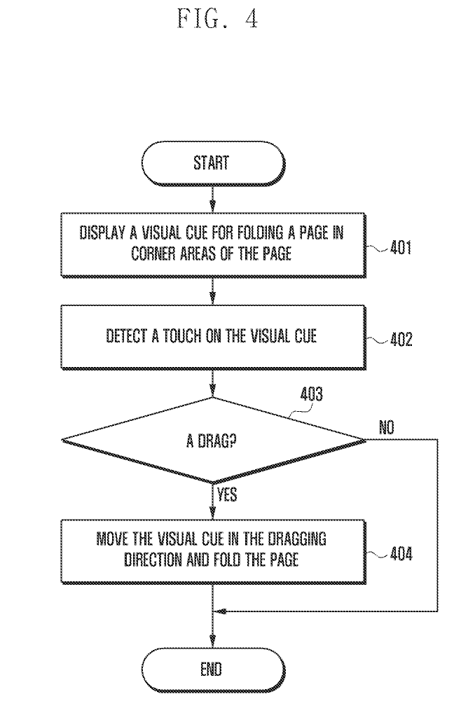

FIG. 4 illustrates a flowchart describing a method for folding over a corner of a page of an e-book according to an exemplary embodiment of the present invention.

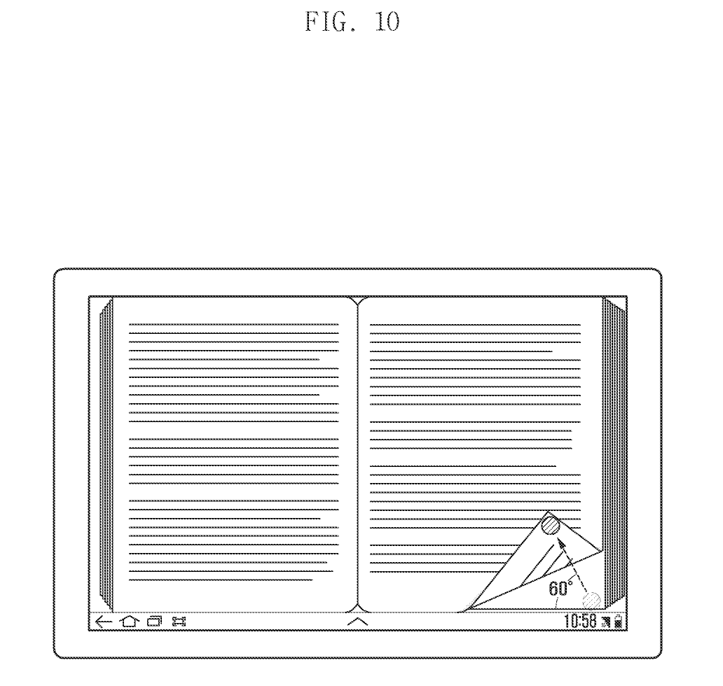

Referring to FIG. 4, the controller 190 controls the display unit 112 to display pages of an e-book in step 401. The pages displayed also display indicators (e.g., visual cues) in the corner areas so that the user can fold the pages over. The corner area refers to an area within a radius of 1 cm from a corner point of a page. The visual cue may be implemented in various shapes or sizes (e.g., right triangles, isosceles triangles, isosceles right triangles as shown in FIGS. 12A and 12B, and the like). For example, one or more legs of the triangle may be 3 mm. Pages displayed may display visual cues in the corners. For example, if one page of an e-book is displayed on the screen, the controller 190 also displays the visual cue in one or more corners. If two pages of an e-book are displayed side by side on the screen, the visual cues are displayed in the top and bottom left corners of the page on the left part of the screen and the top and bottom right corners of the page on the right part of the screen. If any touch gesture is not applied to the visual cues in the page corners in a preset period of time, the visual cues may disappear.

The controller 190 detects a touch action on the visual cue in step 402. The controller 190 determines whether the detected touch action (e.g., a drag, a flick, and the like) moves from the touched visual cue in step 403. If the controller 190 detects a touch action (e.g., a drag) moving from the touched visual cue at step 403, the controller 190 moves the deformed corner area in the dragging direction, folds the deformed corner area over, and displays the deformed corner area on the display unit 112 in step 404. The shapes of folded corner areas may differ from each other according to information regarding the drag action, the page feature, and the like. The exemplary embodiment of the present invention may be further implemented in such a way as to provide variety of feedback (e.g., an audio type of feedback, a haptic type of feedback, and the like) at step 404. If a touch gesture is removed from a page with a folded corner area, the page may retain the folded corner area while the page is turned over. Information regarding a page with a folded corner area is stored in the storage unit 140, and used as a bookmark later.

If the controller 190 does not detect a touch action moving from the touched visual cue at step 403, then the controller 190 may end the process. Alternatively, the controller 190 may continue to poll for input of a touch action moving from the touched visual cue until such a touch action is detected or until another command is input.

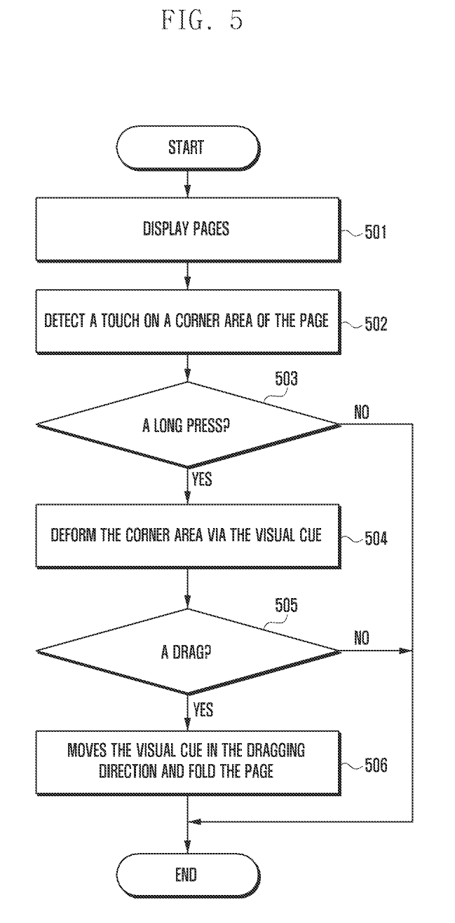

FIG. 5 illustrates a flowchart describing a method for folding over a corner of a page of an e-book according to an exemplary embodiment of the present invention.

Referring to FIG. 5, the controller 190 controls the display unit 112 to display pages of an e-book in step 501. The controller 190 detects a touch in a corner area of a page in step 502. The controller 190 acquires a period of time of the touch by detecting how long the touch contacts the corner area and determines whether the detected touch is a long press gesture, based on the contact time period of the touch in step 503. If the controller 190 ascertains that a long press gesture is detected in the corner area at steps 502 and 503, the controller 190 displays indicators (e.g., visual cues) in the corner areas of the page so that the user can fold the corner areas over in step 504. The controller 190 determines whether the touch action (e.g., a drag, a flick, and the like) moves from the visual cue in step 505. If the controller 190 detects a touch action (e.g., a drag) moving from the touched visual cue at step 505, the controller 190 moves the deformed corner area in the dragging direction, folds the deformed corner area over, and displays the deformed corner area on the display unit 112 in step 506. The shapes of folded corner areas may differ from each other according to information regarding the drag action, the page feature. The exemplary embodiment of the present invention may be further implemented in such a way as to provide variety of feedback (e.g., an audio type of feedback, a haptic type of feedback, and the like) at step 506. If a touch gesture is removed from a page with a folded corner area, the page may retain the folded corner area while the page is turned over. Information regarding a page with a folded corner area is stored in the storage unit 140, and used as a bookmark later.

If the controller 190 does not detect a long touch at step 503 or a corresponding touch action at step 505, then the controller 190 may end the process. Alternatively, the controller 190 may continue to poll for an input of a corresponding touch action until such a touch action is detected or until another command is input.

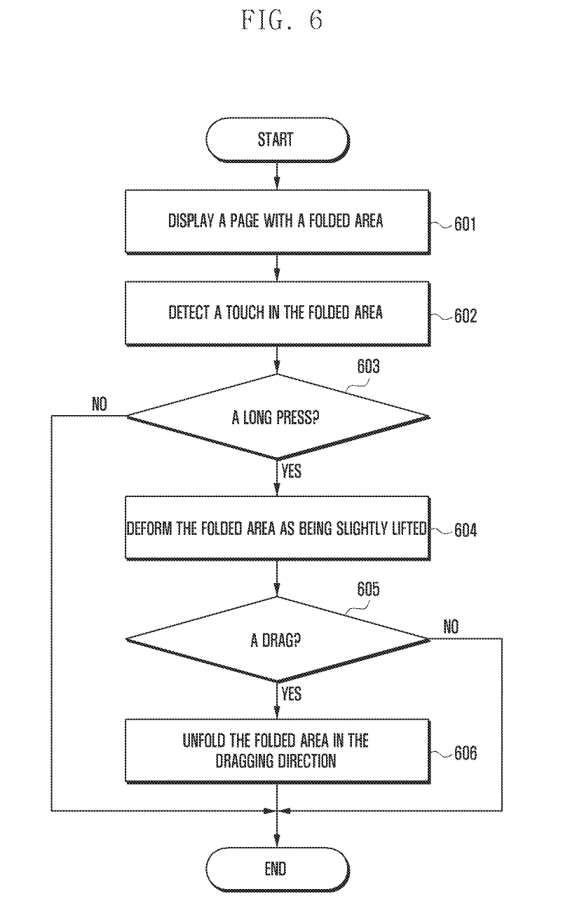

FIG. 6 illustrates a flowchart describing a method for opening pages of an e-book with folded portions according to an exemplary embodiment of the present invention.

Referring to FIG. 6, the controller 190 controls the display unit 112 to display pages of an e-book with folded portions in step 601. The controller 190 detects a touch action in the folded portion in step 602. The folded portion may be the entire folded area of a page or part of the entire folded area (e.g., a corner area). The corner area may refer to an area within a radius of 1 cm from a corner point of a page.

The controller 190 acquires a period of time of the touch by detecting how long the touch contacts the folded portion and determines whether the detected touch is a long press gesture, based on the contact time period of the touch in step 603. If the controller 190 ascertains that a long press gesture is detected in the folded portion at steps 602 and 603, the controller 190 deforms the folded portion of the page (e.g., the corner area) as being slightly lifted, for example, and displays the folded portion of the page on the display unit 112 in step 604. Exemplary embodiments of the present invention may be modified in such a way that a visual cue is displayed in the corner area at step 604, instead of deforming the corner area as being slightly lifted. Alternatively, if the visual cue has been displayed in the corner area from the beginning, exemplary embodiments of the present invention may be modified in such that steps 603 and 604 are omitted.

The controller 190 determines whether a touch action (e.g., a drag, a flick, and the like) moves from the deformed corner area (or the visual cue) in step 605. If the controller 190 detects a touch action (e.g., a drag) moving from the deformed corner area (or the visual cue) at step 605, the controller 190 moves the deformed corner area (or the visual cue) in the dragging direction, folds the deformed corner area over, and displays the deformed corner area on the display unit 112 in step 606. For example, if the touch action moves the folded corner area in the direction for unfolding the folded corner area, opposite to the direction for folding the corner area over, the controller 190 unfolds the folded corner area. The unfolded angle of the folded portion may vary according to the position of the touch.

If the controller 190 does not detect a long touch at step 603 or a corresponding touch action at step 605, then the controller 190 may end the process. Alternatively, the controller 190 may continue to poll for an input of a corresponding touch action until such a touch action is detected or until another command is input.

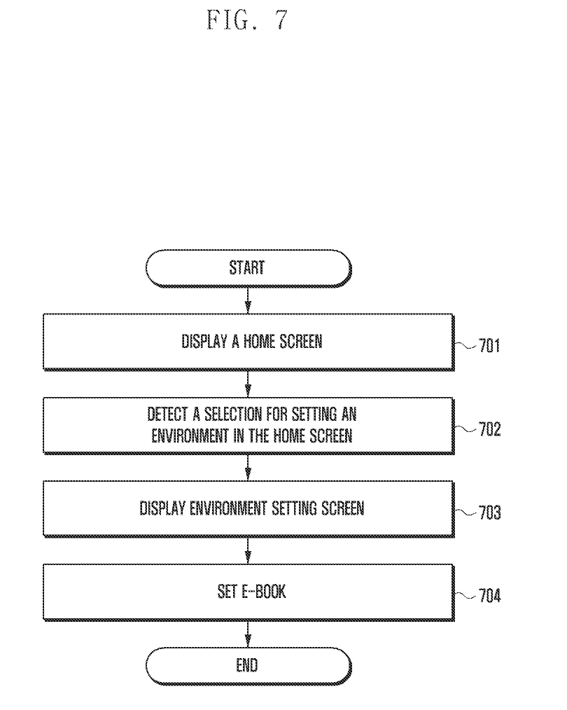

FIG. 7 illustrates a flowchart describing a method for setting an e-book according to an exemplary embodiment of the present invention.

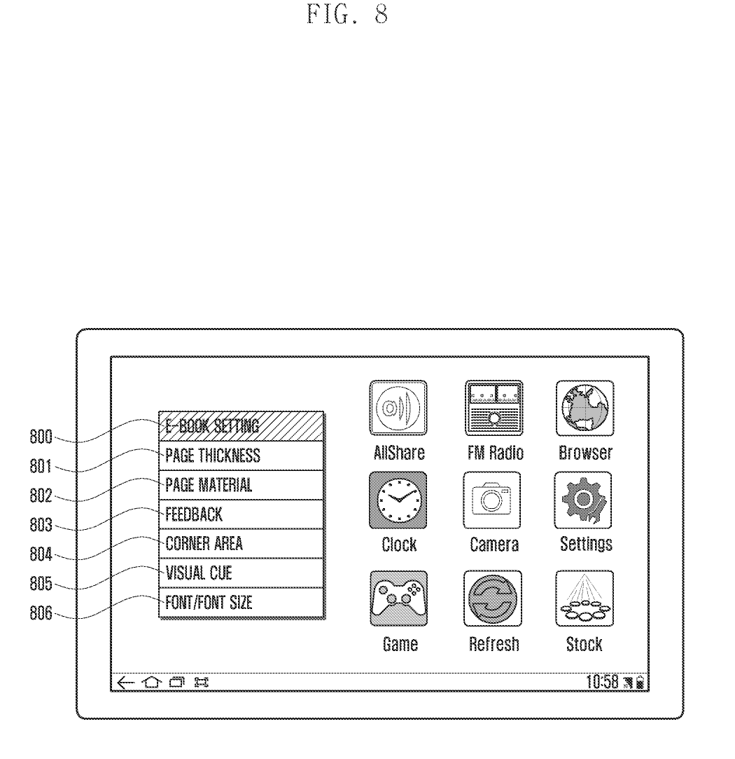

Referring to FIG. 7, the controller 190 controls the display unit 112 to display a home screen in step 701. The home screen shows an icon corresponding to the settings for the mobile device 100. If the user touches the icon corresponding to the settings, the controller 190 detects the user's touch thereon in step 702. The controller 190 controls the display unit 112 to display a screen corresponding to the settings for the mobile device 100 in step 703. The controller 190 sets the settings for e-books in step 704. The user can operate the touch panel 111 on the preference setting screen to set the preference for the mobile device 100, in particular, the environment for e-books. The information regarding the settings for e-book is stored in the storage unit 140, and used when the e-book application 142 is executed. The preference setting screen may include a variety of items according to the performance and functions of the mobile device 100. For example, the preference setting screen may include a number of items related to a wireless network, a location service, sound, display, security, e-book, and the like. If an e-book item is touched, the controller 190 controls the display unit 112 to display a screen for setting e-books, which is shown in FIG. 8.

FIG. 8 illustrates a screen for setting an e-book, according to an exemplary embodiment of the present invention.

Referring to FIG. 8, the display unit 112 displays an e-book setting screen 800 under the control of the controller 190. The e-book setting screen 800 includes a number of items including, page thickness 801, page material 802, feedback 803, corner area 804, visual cue 805 and font/font size 806, and the like. Page thickness 801 and page material 802 may be set as 75 g/m² and a printed paper as described in Table 1. Page thickness 801 and material 802 may be set as default values by the e-book manufacturers, which may not be altered by the user. Feedback 803 is an item to set a type of feedback to be provided to the user. For example, the user may set feedback 803 to enable one or more, all, or a combination of the animation, vibration, and sound effect to operate. Corner area 804 is an item to set the radius from the corner point of a page, thereby setting the corner area. For example, corner area 804 may be set to 1 cm or to vary in the area. Visual cue 805 is an item to set an option as to whether visual cues are displayed. Font/font size 806 is an item to set the font and size of letters when they are displayed on the display unit 112. For example, font and font size may be set to ‘Gothic’ and ‘12 point,’ respectively.

A detailed description of exemplary embodiments of the present invention will be provided referring to the exemplary screens. The types of display modes for a screen are divided into a landscape mode and a portrait mode. The mobile device 100 displays two pages side by side in a landscape mode and one page in a portrait mode. It should be understood that exemplary embodiments of the present invention are not limited by the types of display modes. If the user changes an orientation of the mobile device 100, the sensing unit 185 detects the changed orientation and transfers the signal to the controller 190. In that case, the controller 190 determines the display mode, based on the signal of the detected orientation state.

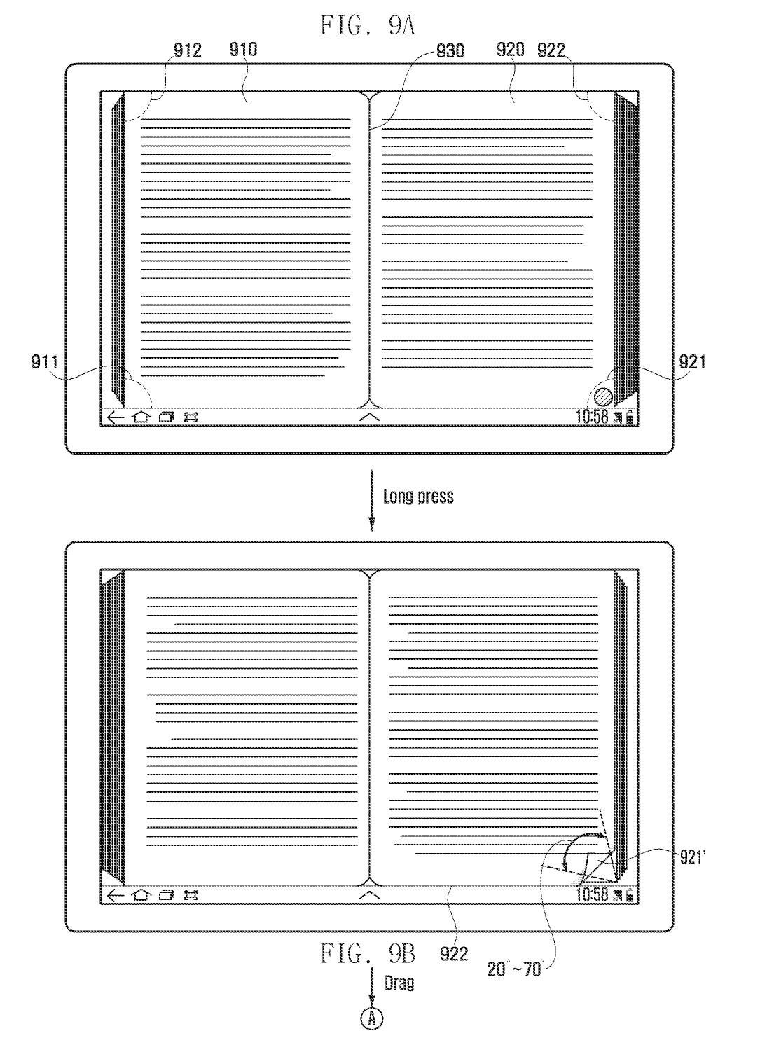

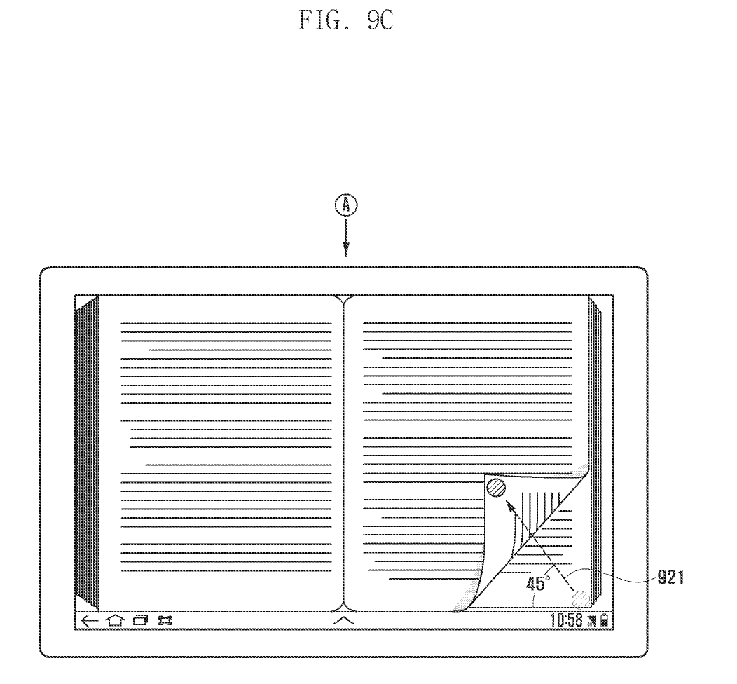

FIGS. 9A to 9C illustrate screens describing a method for folding a page of an e-book according to an exemplary embodiment of the present invention. FIG. 10 illustrates a screen describing a method for folding a page of an e-book according to an exemplary embodiment of the present invention. FIG. 11 illustrates a screen describing a method for folding a page of an e-book according to an exemplary embodiment of the present invention.

Referring to FIGS. 9A to 9C, the controller 190 controls the display unit 112 to operate in landscape mode where one part 910 and the other part 920 of the pages of an e-book are displayed side by side. One part of the pages 910 is located at the left portion of the screen and is called a first part. Likewise, the other part of the pages 920 is located at the right portion of the screen and is called a second part. The reference number 930 corresponds to the gutter of the e-book. If the controller 190 detects a long press in a first corner area of the second part 920 (i.e., a bottom right corner area 921), the controller 190 deforms the area 921 as being slightly lifted, which is called a slightly lifted area 921′. It should be understood that the other corner areas (e.g., a top right corner area 922, a bottom left corner area 911, and a top left corner area 912) may also be deformed via the long press. If a touch tool is the user's hand, or finger, the slightly lifted area 921′ may not be visible to the user until the user removes the user's hand/finger from the area. In addition to the deformation of the bottom right corner area 921, the controller 190 may further provide a variety of items of feedback (e.g., an audio type of feedback such as sound effects, a haptic type of feedback such as vibration), and the like). If the controller 190 controls the display unit 112 to operate in portrait mode, the display unit 112 may display one page of an e-book on the screen. In that case, the environment may be set in such a way that one or more corners of the displayed page are corner areas that can be deformed via a long press.

The controller 190 detects a touch action (e.g., a drag) moving from the slightly lifted area 921′ at the bottom right corner. The controller 190 moves and folds the slightly lifted area 921′ in the direction of the detected drag action (e.g., at an angle of 45° clockwise with respect to the bottom edge 922 of the page on the second part 920 as shown in FIG. 9C). In that case, the drag direction may be restricted to a range of angle (e.g., 20°˜70° clockwise with respect to the bottom edge 922 of the page on the second part 920). For example, if the drag action moves in a direction at an angle less than 20° or greater than 70°, clockwise with respect to the bottom edge 922 of the page on the second part 920, the controller 190 may not fold the slightly lifted area 921′. In addition, the controller 190 may perform a page folding operation based on information regarding the detected drag action (e.g., the movement direction, the movement distance, the speed, and the like).

Referring to FIG. 10, a page with a folded area when the drag action moves in a direction at an angle of 60° clockwise with respect to the bottom edge 922 of the page on the second part 920 is illustrated.

Referring to FIG. 11, a page with a folded area when the drag action moves in a direction at an angle of 30° clockwise with respect to the bottom edge 922 of the page on the second part 920 is illustrated.

As shown in FIGS. 9C, 10 and 11, the pages are folded in different shapes according to the directions of the drag action. Alternatively, the pages may also be folded in different shapes according to the movement distance of the drag action, the speed of the drag action, and the like. Although the corner area at the bottom right of the page on the second part 920 is folded as shown in FIG. 9C, the corner area of the top right of the page may also be folded. In addition, the corner areas at the bottom left and top left of a page on the first part 910 may also be folded.

In addition to the information regarding to the drag action, the controller 190 may also perform a page folding operation, considering the page feature (e.g., the thickness, weight, material, and the like). In that case, the pages may be folded in different shapes according to the page feature. For example, the folded shapes of pages of magazines made of a stiff material may differ from those of newspapers made of a thin material. Exemplary embodiments of the present invention may be implemented in such a way as to provide variety of feedback (e.g., an audio type of feedback such as sound effects, a haptic type of feedback such as vibration, and the like) in addition to the animation of a page as being folded. If a touch gesture is removed from a page with a folded portion, the page may retain the folded page while the page is turned over. Information regarding the folded page is stored in the storage unit 140, and used as a bookmark later.

FIGS. 12A and 12B illustrate screens describing a method for folding a page of an e-book according to an exemplary embodiment of the present invention.

Referring to FIGS. 12A and 12B, the controller 190 controls the display unit 112 to operate in landscape mode in which one part 1210 and the other part 1220 of the pages of an e-book are displayed side by side. One part of the pages 1210 is located at the left portion of the screen and is called a first part. Likewise, the other part of the pages 1220 is located at the right portion of the screen and is called a second part. Although the controller 190 has not detected any touch action on the pages displayed on the screen, the controller 190 controls the display unit 112 to display a visual cue 1211 in the top left corner and/or a visual cue 1212 in the bottom left corner of the page on the first part 1210. Likewise, the controller 190 controls the display unit 112 to display a visual cue 1221 in the top right corner and/or a visual cue 1222 in the bottom right corner of the page on the second part 1220. If the controller 190 detects a touch action (e.g., a drag, moving from the visual cue 1222), the controller 190 moves the corner area in the dragging direction and folds the corner area over. The dragging direction may have a preset condition. The shapes of folded corner areas may differ from each other according to information regarding the drag action (e.g., the drag direction, the movement distance, the speed, and the like), the page feature (e.g., the thickness, weight, material, and the like). Exemplary embodiments of the present invention may be implemented in such a way as to provide a variety of feedback (e.g., an audio type of feedback such as sound effects), a haptic type of feedback such as vibration, and the like) in addition to the animation of a page as being folded. If a touch gesture is removed from a page with a folded portion, the folded page is retained while the page is turned over. The information regarding the folded page is stored in the storage unit 140, and used as a bookmark later. Exemplary embodiments of the present invention may be implemented in such a way that the controller 190 controls the display unit 112 to operate in portrait mode in which one page is displayed on the screen. In that case, the controller 190 may display the visual cue in one or more corner areas of the page.

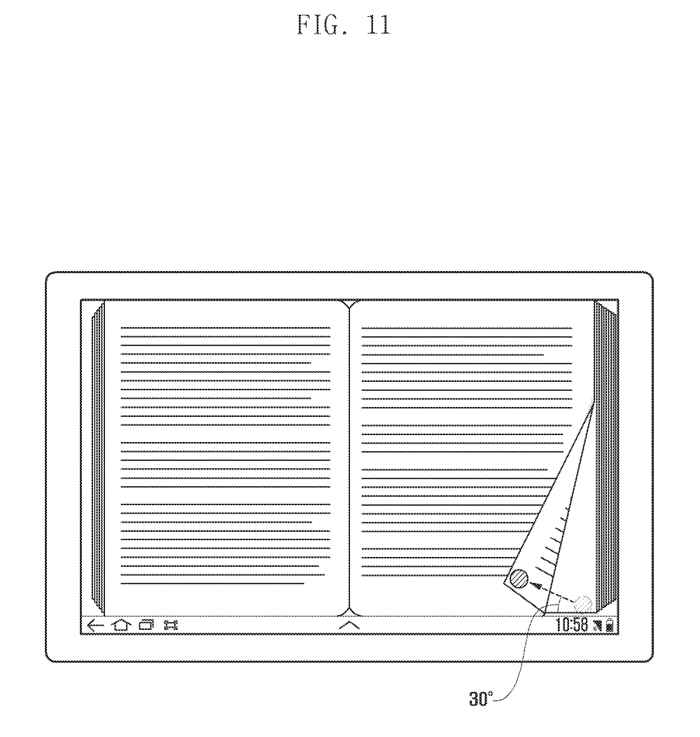

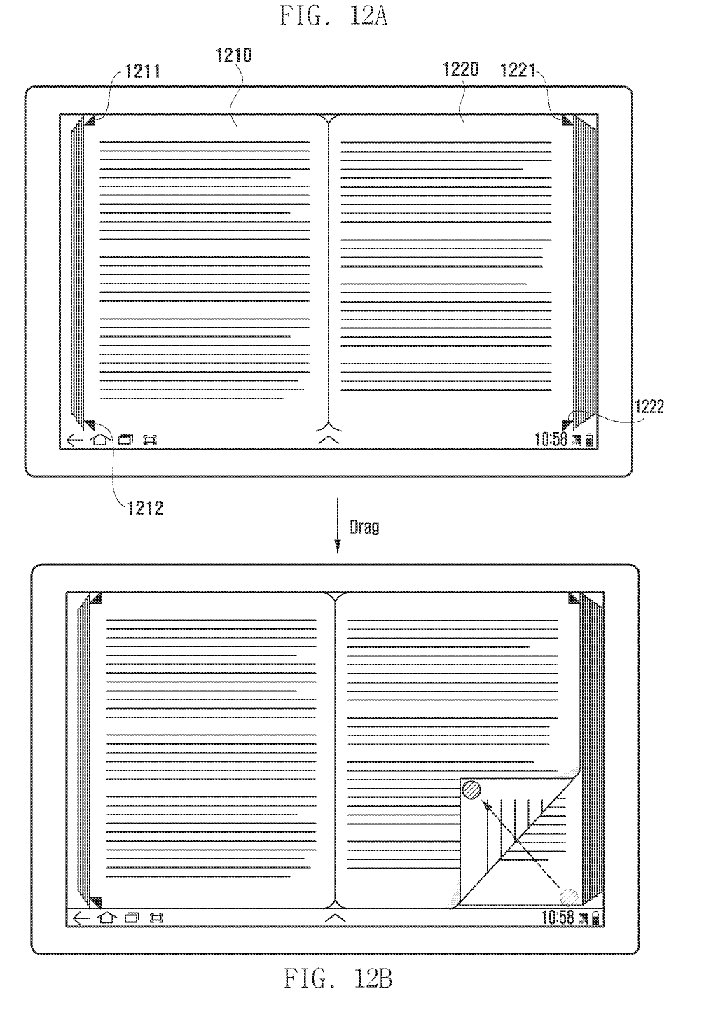

FIGS. 13A and 13B illustrate screens describing a method for folding a page of an e-book according to an exemplary embodiment of the present invention.

Referring to FIGS. 13A and 13B, the controller 190 controls the display unit 112 to operate in landscape mode in which one part 1310 and the other part 1320 of the pages of an e-book are displayed side by side. One part of the pages 1310 is located at the left portion of the screen and is called a first part. Likewise, the other part of the pages 1320 is located at the right portion of the screen and is called a second part.

If the controller 190 detects a touch action (e.g., a long press) in the bottom right corner area 1321 of the page displayed on the second part 1320, the controller 190 controls the display unit 112 to display a visual cue 1322. The visual cue 1322 may disappear if there is no touch action in a preset period of time. It should be understood that a visual cue may also be displayed in the top right corner area 1323 of the page on the second part 1320. Likewise, it should be understood that visual cues may also be displayed in the bottom left 1311 and top left 1312 corner areas of the page on the first part 1310. Exemplary embodiments of the present invention may also be implemented in such a way as to provide various types of feedback (e.g., an audio type of feedback such as sound effects, a haptic type of feedback such as vibration, and the like) in addition to the visual feedback, such as a visual cue 1322. If the controller 190 detects a touch action (e.g., a drag), moving from the visual cue 1322, the controller 190 moves the corner area in the dragging direction and folds it over.

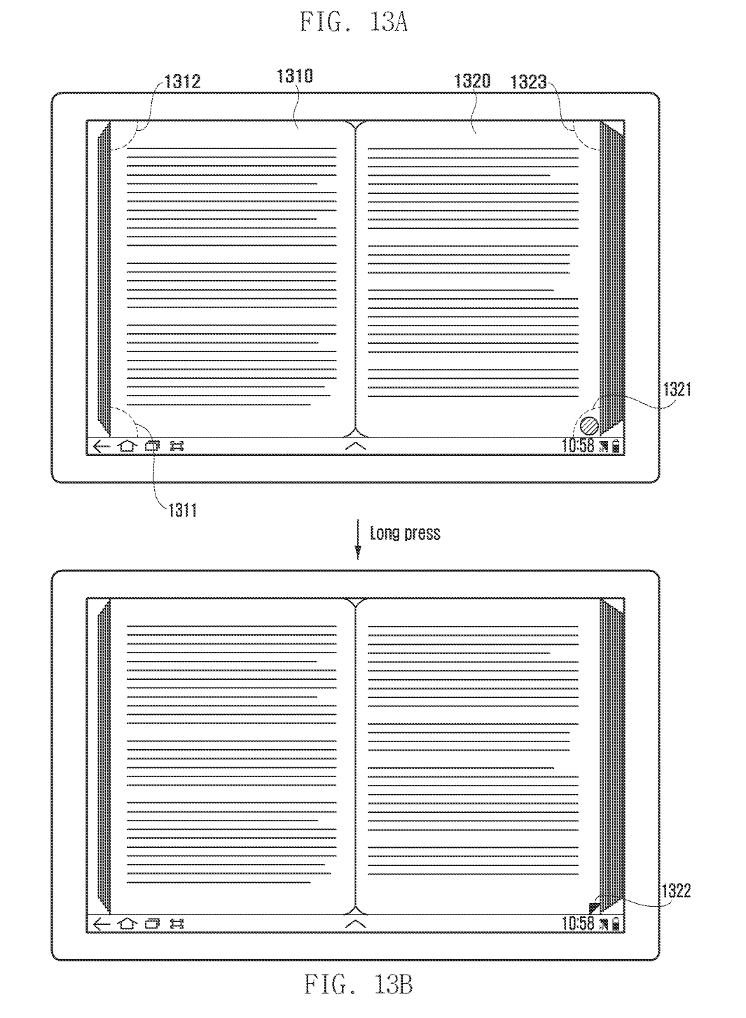

FIGS. 14A and 14B illustrate screens describing a method for folding a page of an e-book according to an exemplary embodiment of the present invention.

Referring to FIGS. 14A and 14B, if the controller 190 detects that a corner of a page reaches a preset location, the controller 190 moves the corner to the closest edge. For example, as illustrated in FIGS. 14A and 14B, the controller 190 controls the display unit 112 to operate in landscape mode in which one part 1410 and the other part 1420 of the pages of an e-book are displayed side by side. One part of the pages 1410 is located at the left portion of the screen and is called a first part. Likewise, the other part of the pages 1420 is located at the right portion of the screen and is called a second part. If the controller 190 detects a touch action (e.g., a drag) moving from the bottom right corner area of the page on the second part 1420, the controller 190 moves the area in the detected dragging direction 1450 and folds the page over. For example, if the controller 190 ascertains that the bottom right corner 1421 of the page moves over a threshold line 1440, the controller 190 moves the corner 1421 to the closest edge (e.g., moves the left edge of the page on the second part 1420 to the gutter line 1430), and then folds the page over. The threshold line 1440 refers to a virtual line that is set on the page of the second part 920, parallel to the gutter 1430 and spaced apart from the gutter 1430 by a distance (e.g., 15 mm) It should be understood that the threshold line 1440 may be set to a certain location. Although the exemplary embodiment of the present invention is implemented in such a way that, when the bottom right corner 1421 crosses over the threshold line 1440, the controller 190 moves the bottom right corner 1421 to the closest edge, it should be understood that exemplary embodiments of the present invention are not so limited. For example, a condition to automatically move the bottom right corner 1421 to an edge may be an option so as to determine whether the touch 1460 crosses over the threshold line 1440. The bottom right corner 1421 may cross the gutter 1430 and be located at a position on the page of the first part 1410.

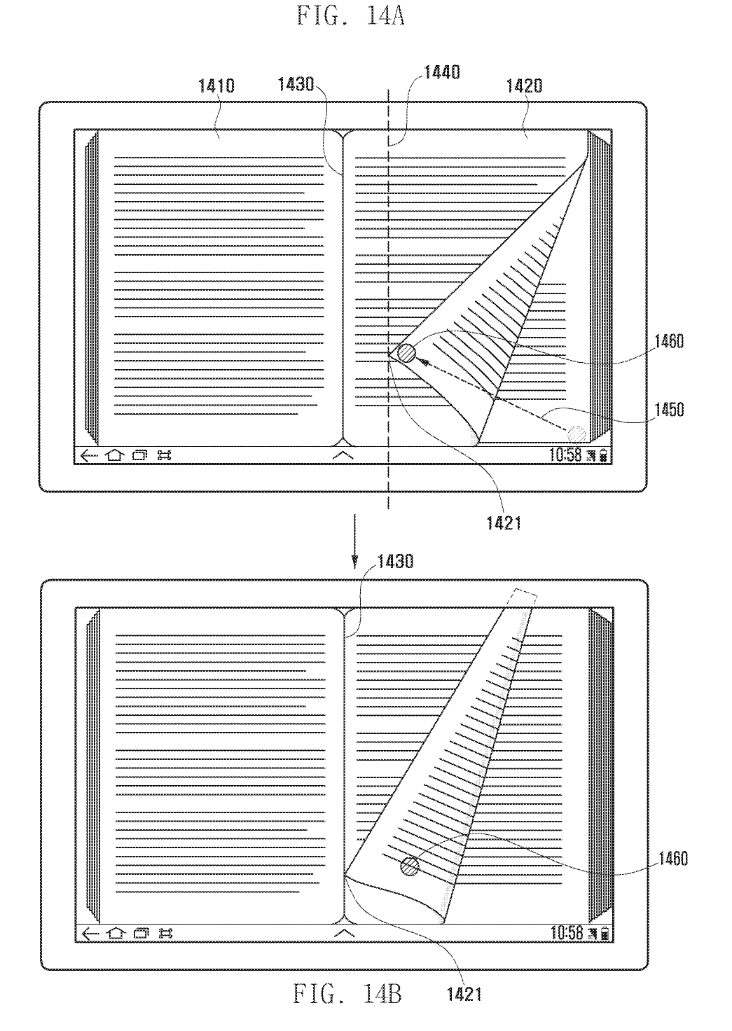

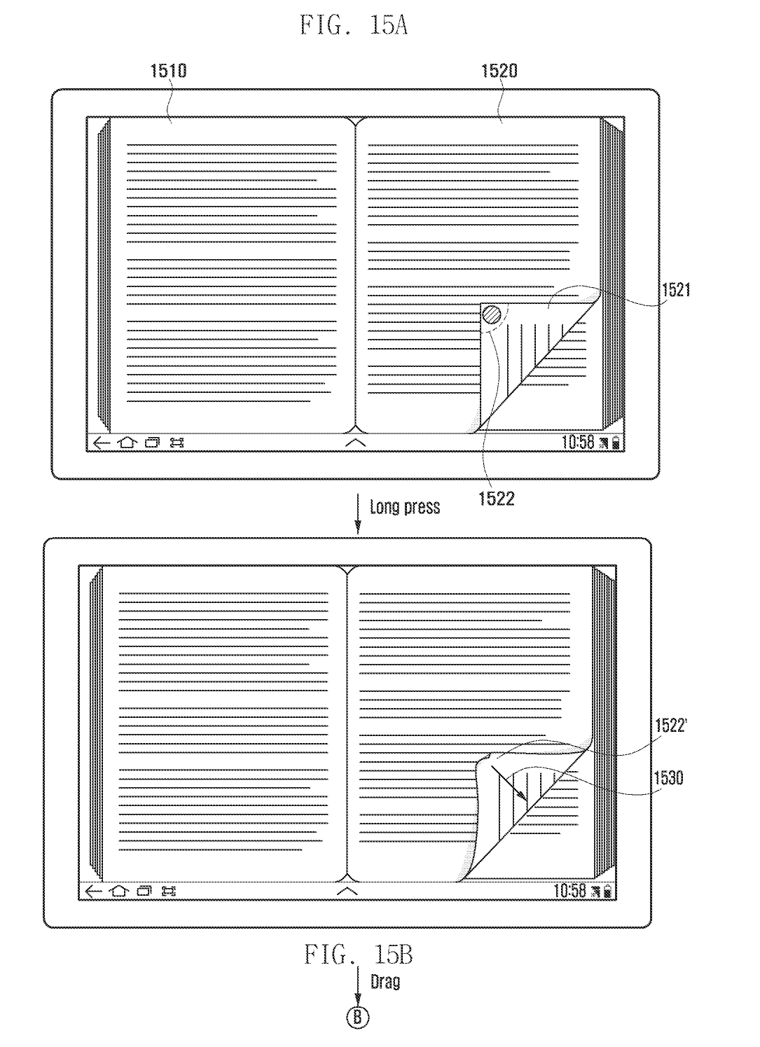

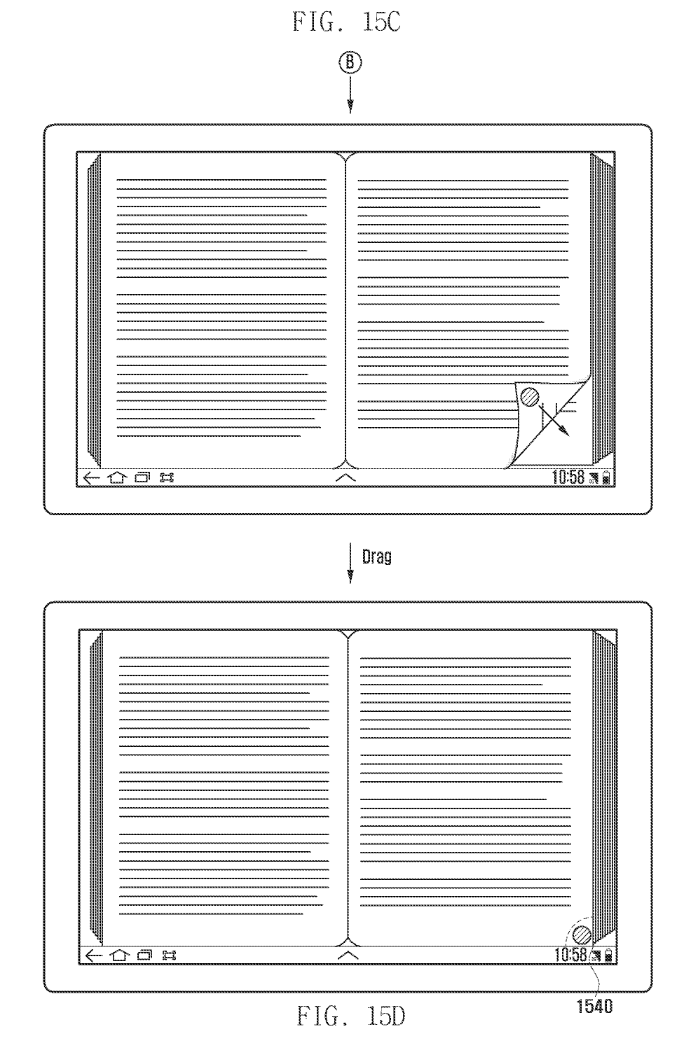

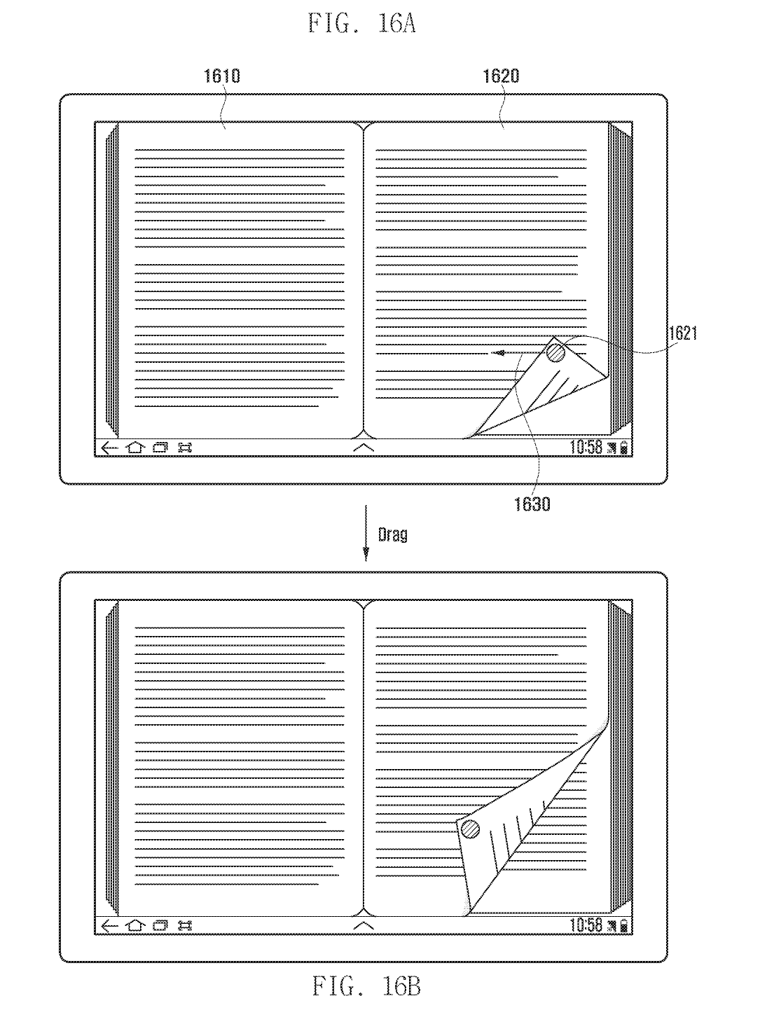

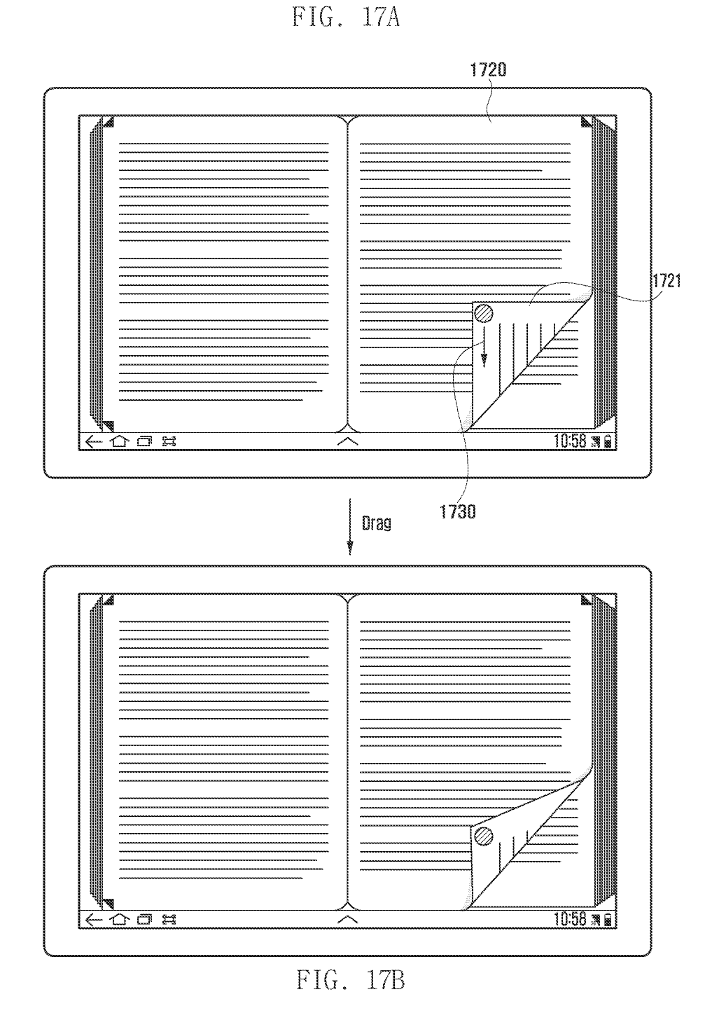

FIGS. 15A to 15D, illustrate screens describing a method for deforming a folded page according to an exemplary embodiment of the present invention. FIGS. 16A and 16B illustrate screens describing a method for deforming a folded page according to an exemplary embodiment of the invention. FIGS. 17A and 17B illustrate screens describing a method for deforming a folded page according to an exemplary embodiment of the invention.

Referring to FIGS. 15A to 15D, the controller 190 controls the display unit 112 to operate in landscape mode in which one part 1510 and the other part 1520 of the pages of an e-book are displayed side by side. One part of the pages 1510 is located at the left portion of the screen and is called a first part. Likewise, the other part of the pages 1520 is located at the right portion of the screen and is called a second part. The second part 1520 is displayed with a page with a folded area (e.g., a folded page). If the controller 190 detects a long press in a folded area 1521, in particular, a corner area 1522, the controller 190 deforms the corner area 1522 as being slightly lifted, thereby creating a slightly lifted area 1522′. The controller 190 detects a touch action (e.g., a drag) moving from the slightly lifted area 1522′. For example, if the detected drag action moves in the diagonal direction 1530, the controller 190 moves the corner area 1522 in the direction and unfolds the corner area 1522. The unfolded angle of the corner area may vary according to the touch moving. For example, the closer to the bottom right corner 1540 the touch moves, the larger the unfolded area is. If the controller 190 detects a touch gesture (e.g., multi-touch, and the like) in the corner area 1522, the controller 190 may restore the corner area 1522 to the original form before the corner area 1522 has been folded. It should be understood that the touch gesture for restoring a folded portion may correspond to various types of touch actions.

Referring to FIGS. 16A and 16B, the controller 190 controls the display unit 112 to operate in landscape mode where one part 1610 and the other part 1620 of the pages of an e-book are displayed side by side. One part of the pages 1610 is located at the left portion of the screen and is called a first part. Likewise, the other part of the pages 1620 is located at the right portion of the screen and is called a second part. The second part 1620 is displayed with a page with a folded area 1621 (e.g., a folded page). If the controller 190 detects a long press in the folded area 1621, the controller 190 deforms the folded area 1621 as being slightly lifted, thereby creating a slightly lifted area. The controller 190 detects a touch action (e.g., a drag) moving from the slightly lifted area. The controller 190 moves the corner area in the direction of the detected drag action 1630 (e.g., to the first part 1610), and then deforms the folded shape of the page on the second part 1620.

Referring to FIGS. 17A and 17B, if the controller 190 detects a touch moving from the corner area in a folded area 1721 of the page on the second part 1720, in the direction 1730 of the bottom edge, the controller 190 moves the folded area 1721 in the bottom edge direction 1730, thereby deforming the folded shape of the page. As described above referring to FIGS. 15A to 15D to FIGS. 17A and 17B, the folded areas may be deformed in different shapes according to locations at which touches are made, movement directions, movement distances, and the like.

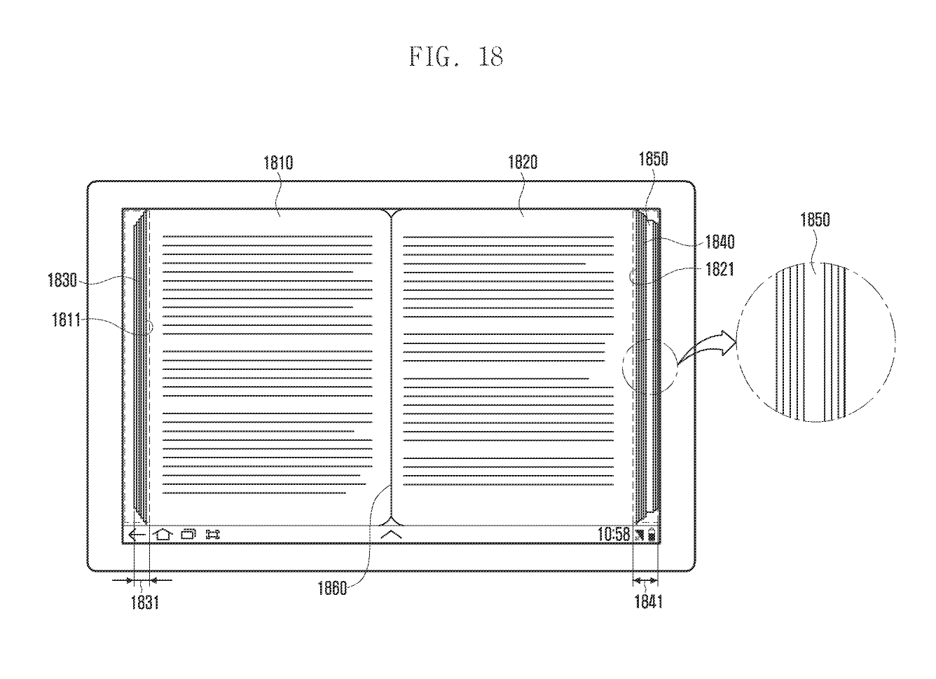

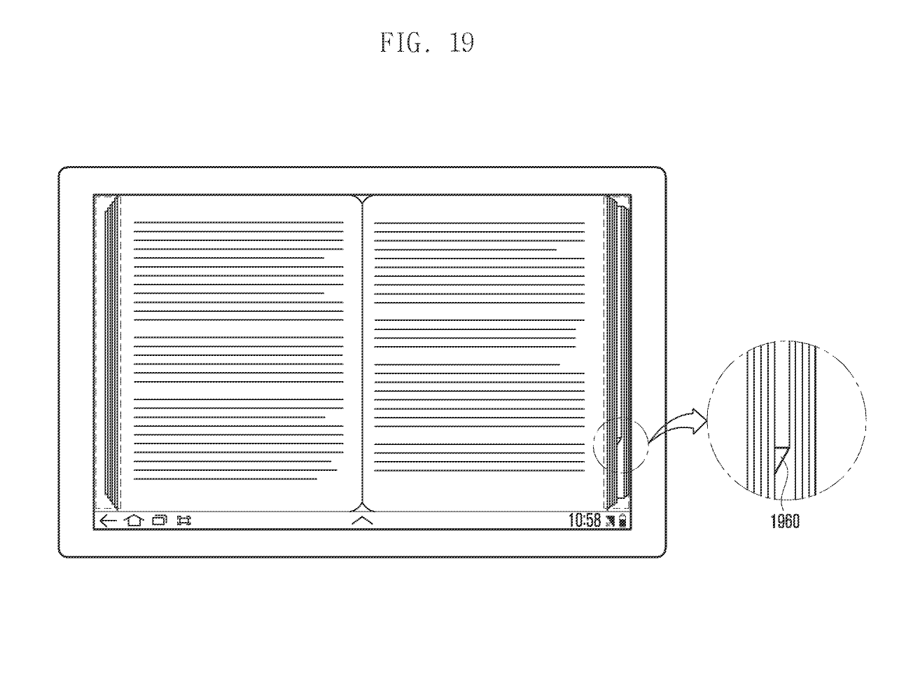

FIG. 18 illustrates a screen describing a method for displaying a volume of an e-book, according to an exemplary embodiment of the present invention. FIG. 19 illustrates a screen describing a method for displaying a volume of an e-book, according to an exemplary embodiment of the invention. FIG. 20 illustrate a screen describing a method for displaying a volume of an e-book, according to an exemplary embodiment of the invention.

Referring to FIG. 18, the controller 190 controls the display unit 112 to operate in a landscape mode in which one part 1810 and the other part 1820 of the pages of an e-book are displayed side by side. One part of the pages 1810 is located at the left portion of the screen and is called a first part. Likewise, the other part of the pages 1820 is located at the right portion of the screen and is called a second part. A gutter 1860 is provided between the first part 1810 and the second part 1820 so as to divide the first part 1810 and the second part 1820 of pages of the e-book. The first part 1810 is displayed together with a first volume area 1830 in the left edge 1811. The second part 1820 is also displayed together with a second volume area 1840 in the right edge 1821. For example, the widths 1831 and 1841 of the first 1830 and second 1840 volume areas are proportional to the thickness corresponding to the number of pages (sheets) under the currently opened page, respectively. For example, if an e-book with a total of 100 pages is opened at Page 20 and Page 21, side by side, on left and right portions of the screen, the left edge of 20 pages is displayed, with the corresponding thickness, on the first volume area 1830 and the right edge of the remaining 80 pages is displayed, with the corresponding thickness, on the second volume area 1840. Therefore, the display unit 112 displays the second volume area 1840 of the second part 1820 to be thicker than the first volume area 1830 of the first part 1810.

The controller 190 may provide the volume area with a visual type of feedback to display a user's input information (e.g., information regarding folded pages). The visual type of feedback may be implemented in various forms. For example, as shown in FIG. 18, a page 1850 with a folded corner area may be displayed, on the second volume area 1840, with a greater margin than the other pages including the previous and next pages.

Referring to FIG. 19, an alternative to illustrating a page 1850 with a folded corner area with a greater margin than the other pages may illustrate a page with a folded area may be displayed, on the second volume area, in such a way that the part of the folded area 1960 is displayed between the previous and the next pages on the second volume area.

Referring to FIG. 20, a further alternative for illustrating a page with a folded area may be to display the page with the folded area, on the second volume area, in such a way that the edge 2060 may be distinguished from the edges of the other pages (e.g., in terms of color, shading, and the like). If the controller 190 detects a touch gesture (e.g., a tap) with respect to the information regarding the folded page, the controller controls the display unit 112 to directly open and display the folded page on the screen.

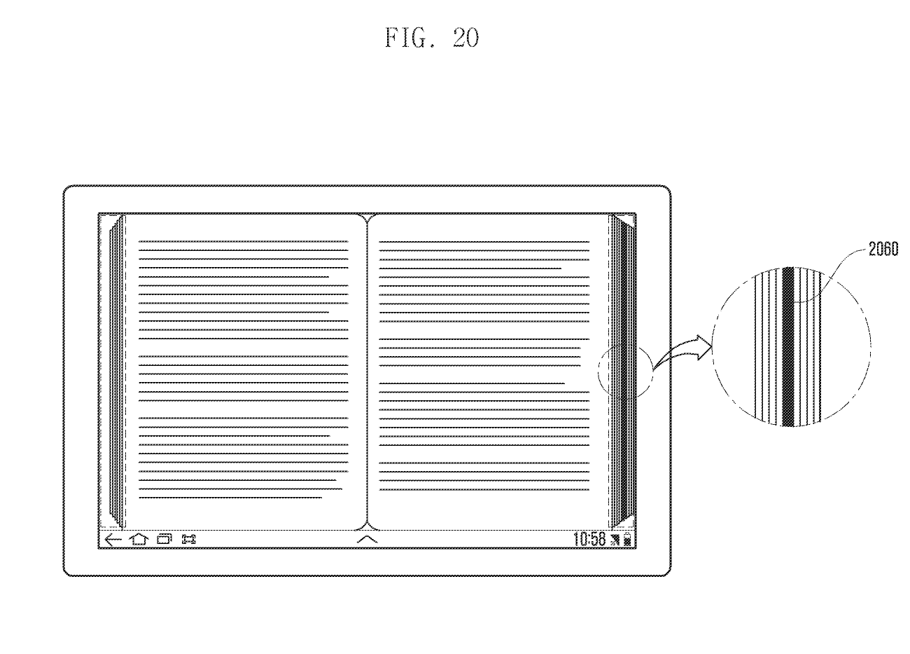

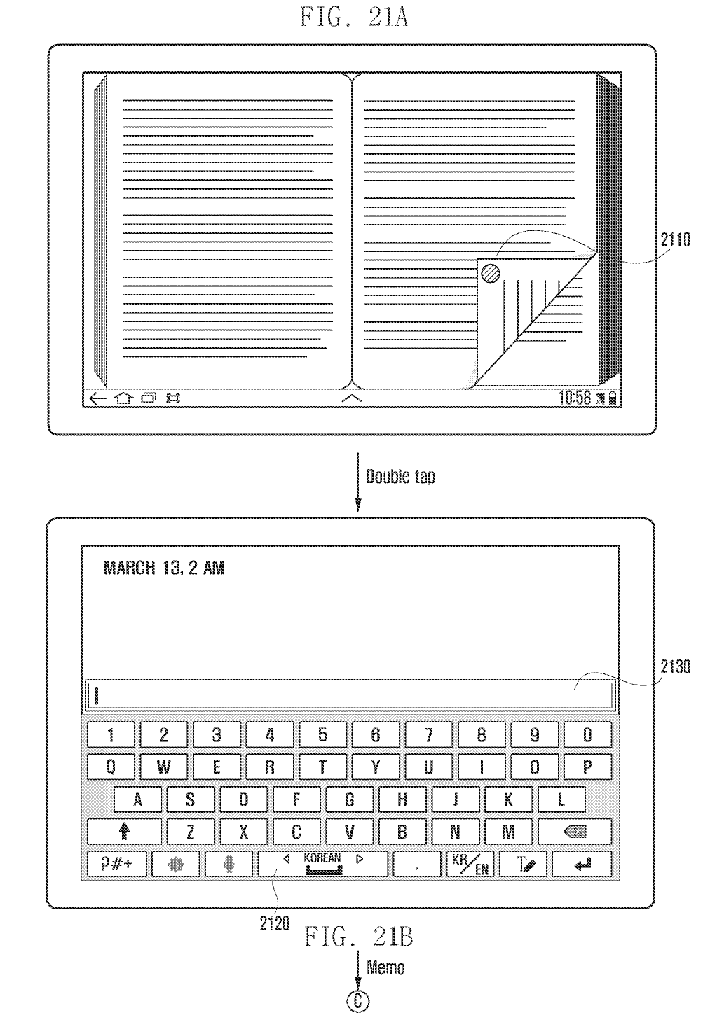

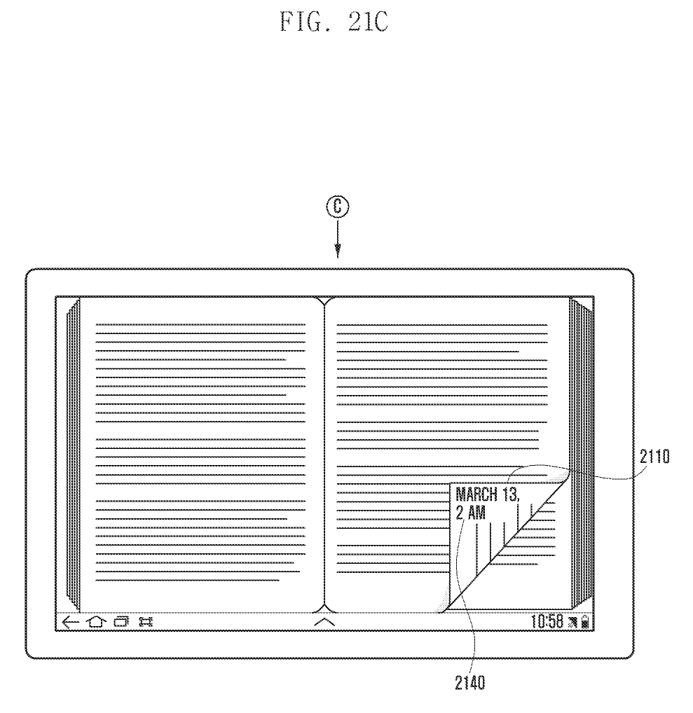

FIGS. 21A to 21C illustrate screens describing a method for making a memo related to a folded page according to an exemplary embodiment of the present invention.

Referring to FIGS. 21A to 21C, the user may make a memo related to a folded page of an e-book in a touch screen-based device. The method for making a memo may be implemented with various modes.

As illustrated in FIGS. 21A to 21C, the controller 190 detects a touch gesture in a folded area 2110. If the controller 190 detects a double tap gesture in the folded area 2110, the controller 190 controls the display unit 112 to display a keypad 2120 and a field 2130 for displaying data input via the keypad 2120. Although not shown in the drawings, the display unit 112 may display a handwriting input screen, instead of displaying the keypad 2120 and the field 2130. If the user inputs a memo 2140 via the keypad 2120 or a handwriting input screen, the controller 190 stores the input memo 2140, as a user's input information, associated with information regarding the folded page (e.g., page number), in the storage unit 140. During the process, the user's input memo may also be displayed on the folded area 2110.

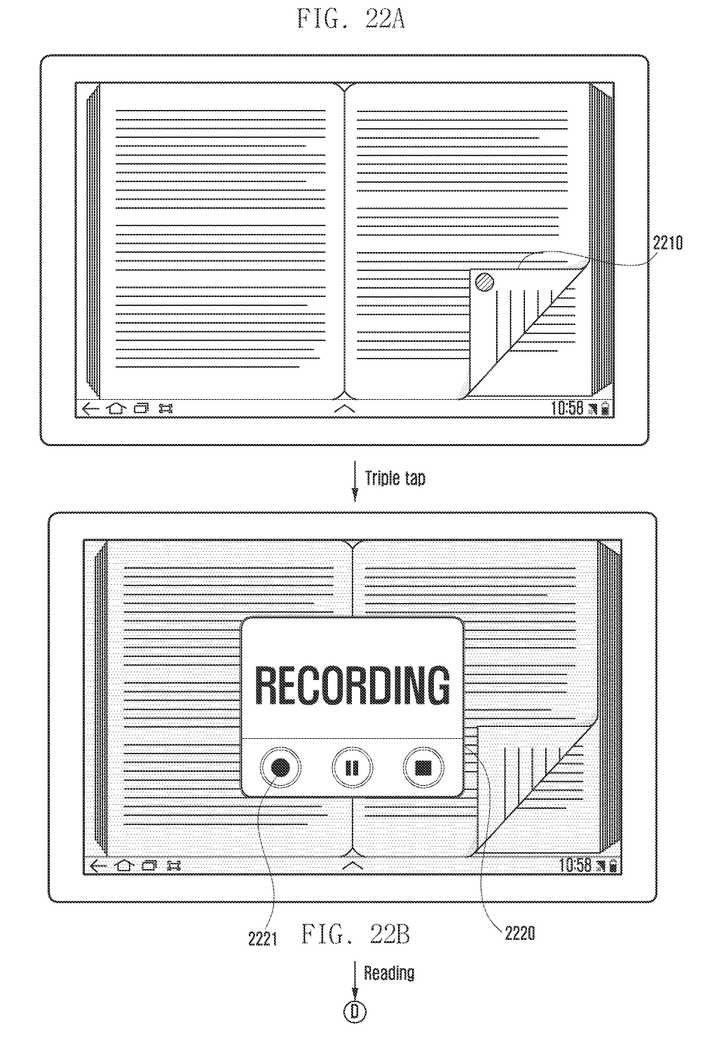

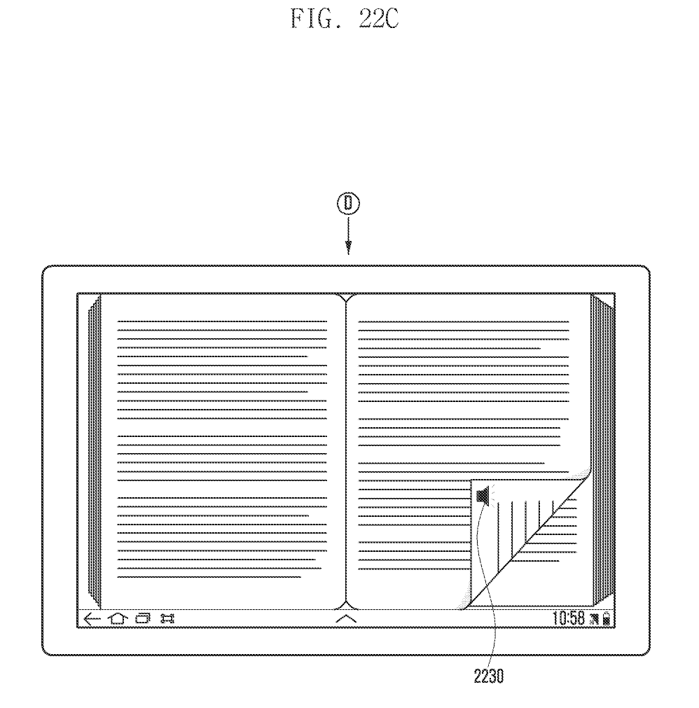

FIGS. 22A to 22C illustrate screens describing a method for recording a voice memo related to a folded page according to an exemplary embodiment of the present invention.

Referring to FIGS. 22A to 22C, the user may make a voice memo related to a folded page of an e-book in the device.

As illustrated in FIGS. 22A to 22C, the controller 190 detects a touch gesture in a folded area 2210. If the controller 190 detects a triple tap gesture in the folded area 2210, the controller 190 controls the display unit 112 to display an audio recording screen 2220. If an audio record button 2221 is selected on the audio recording screen 2220, the controller 190 controls the audio processing unit 160 and the microphone to record voices. The recorded voices serve as a user's input information, and are associated with information regarding the folded page (e.g., page number). The files of recorded voices are stored in the storage unit 140. The voice file may be represented by a tag (e.g., an icon 2230), and the like. The tag may be displayed in the folded area 2210. If the user selects the icon 2230, the corresponding voice file may be played back.

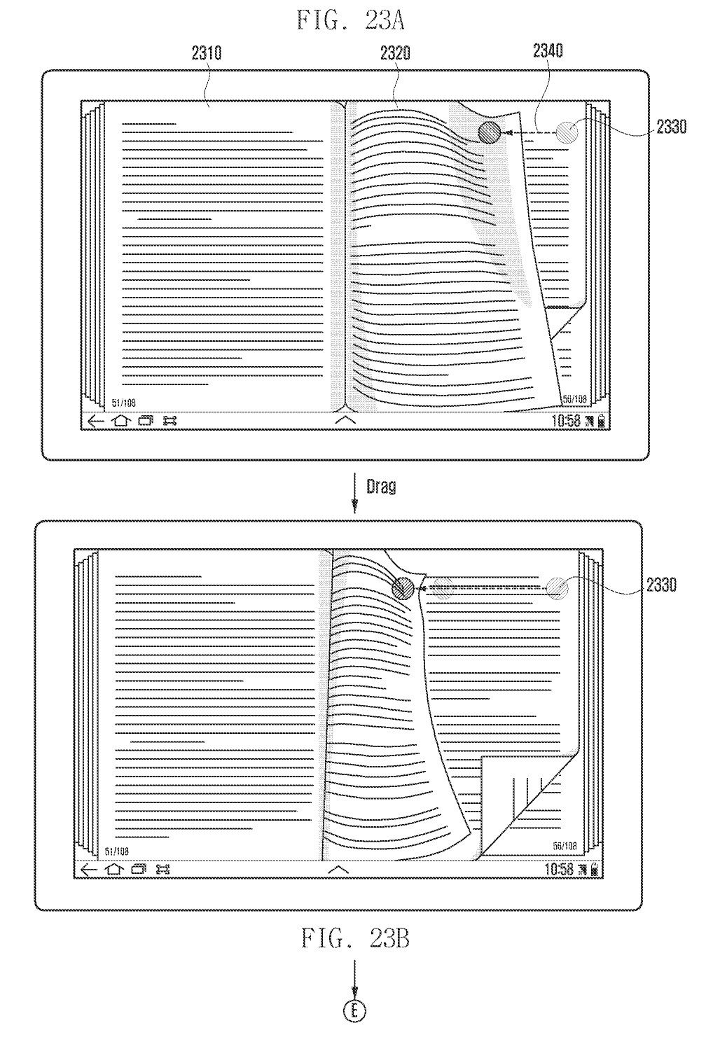

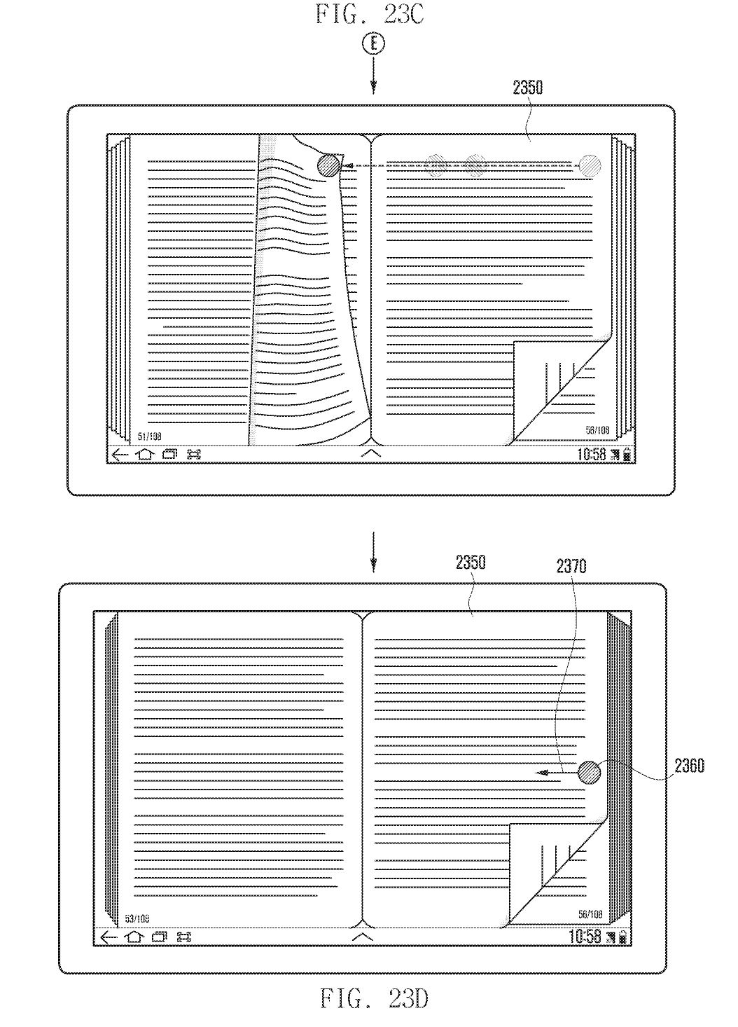

FIGS. 23A to 23D illustrate screens describing a method for stopping turning pages of an e-book according to an exemplary embodiment of the present invention.

Referring to FIGS. 23A to 23D, the controller 190 controls the display unit 112 to operate in a landscape mode in which one part 2310 and the other part 2320 of the pages of an e-book are displayed side by side. One part of the pages 2310 is located at the left portion of the screen and is called a first part. Likewise, the other part of the pages 2320 is located at the right portion of the screen and is called a second part. The controller 190 detects touch gestures for turning over pages on the first part 2310 and second part 2320. For example, if the controller 190 detects a first drag gesture 2340, moving in the left direction from a first location 2230 on the page, close to the fore edge of the second part 2320, the controller 190 prudently deforms the page and turns the page over to the first part 2310 according to the detected first drag gesture 2340. Therefore, the next page 2350 is displayed on the second part 2320. In that case, the user's input information related to the page 2350 (e.g., a memo, a voice memo, highlights, images, bookmarks, folded state, and the like) may also be displayed. The user's input information may be stored in the storage unit 140. In particular, the page 2350 that is newly displayed may be a folded page.

The controller 190 may detect a touch gesture for turning over the page 2350 on the second part. For example, if the controller 190 detects a second drag gesture 2370, moving to the left from a second location 2360 on the page 2350, close to the fore edge of the second part 2320, the controller 190 prudently deforms the page 2350 and turns the page over to the first part 2310 according to the detected second drag gesture 2370. If the controller 190 ascertains that the time difference between the current touch gesture (e.g., the second drag gesture 2370) and the previous touch gesture (e.g., the first drag gesture 2340) is less than or equal to a preset period of time (e.g., 2 seconds) and there is user input information related to the page 2350 (in particular, if the page 2350 has been folded), the controller 190 may not respond to the currently detected touch gesture (i.e., the second drag gesture 2370). In that case, the page 2350 may not be turned over. For example, if the user intends to rapidly turn pages over with skipping the page 2350 with user input information, the controller 190 provides a visual type of feedback that does not turn the page 2350 over. Exemplary embodiments of the present invention may be further implemented in such a way as to provide a variety of items of feedback (e.g., an audio type of feedback such as sound effects, a haptic type of feedback such as vibration, and the like). The threshold period of time for determining whether to turn a page over may be set according to a user's settings, e-book application providers, mobile device manufacturers, and the like. The types of feedback described above may be set to be turned on/off according to a user's settings.

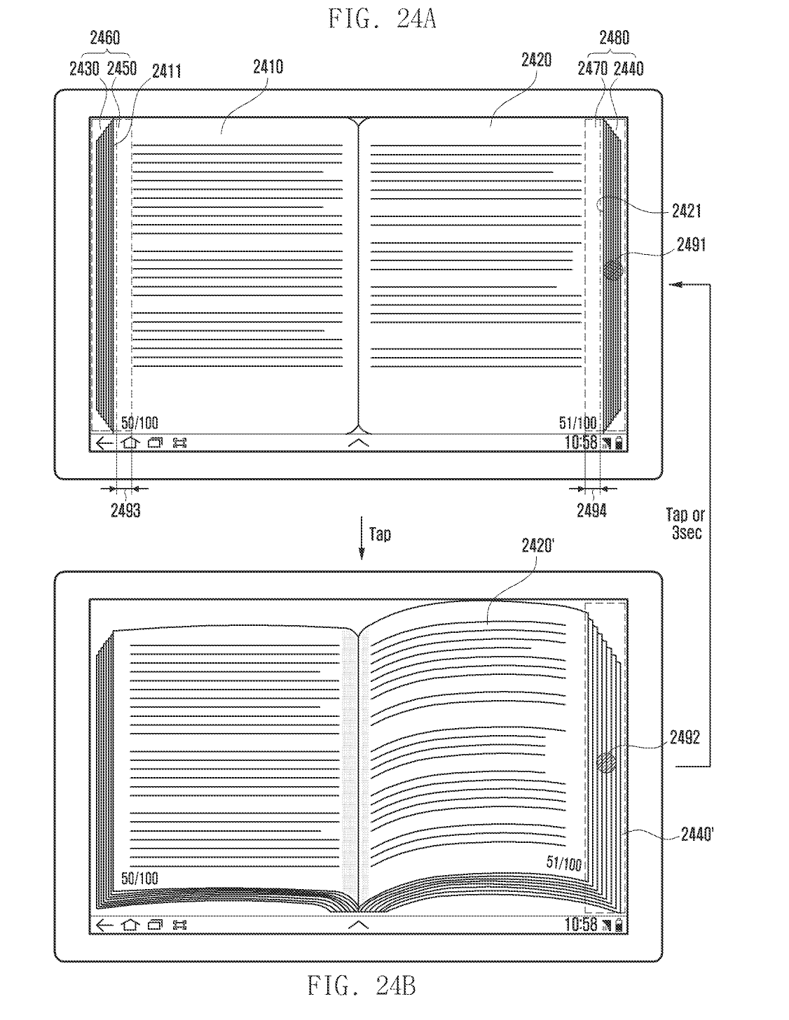

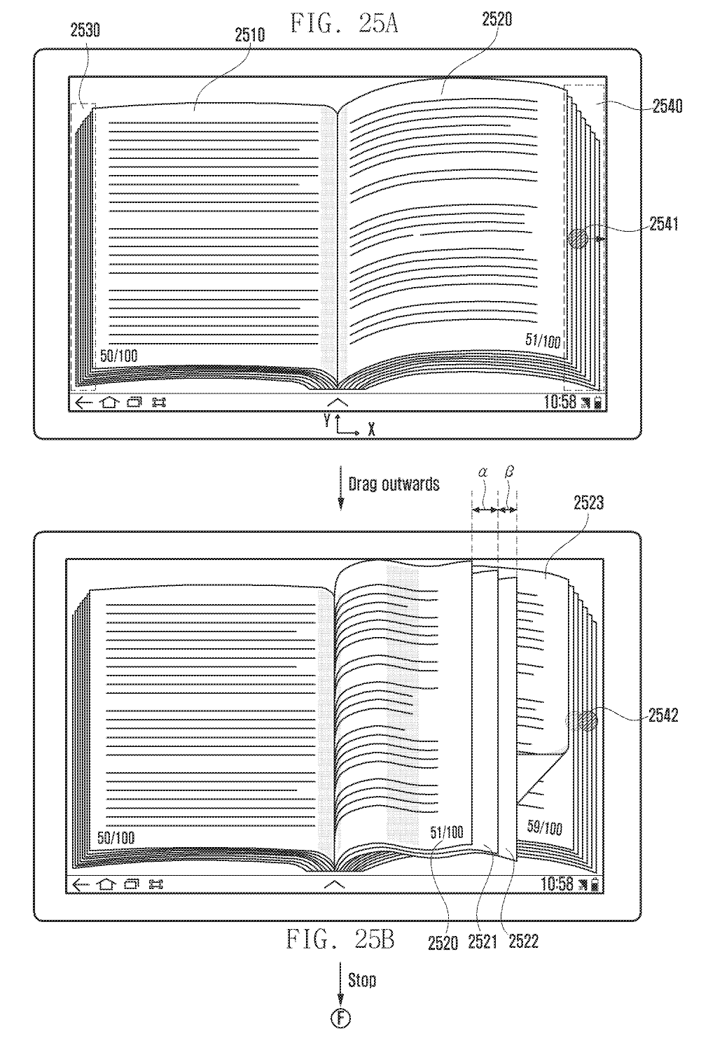

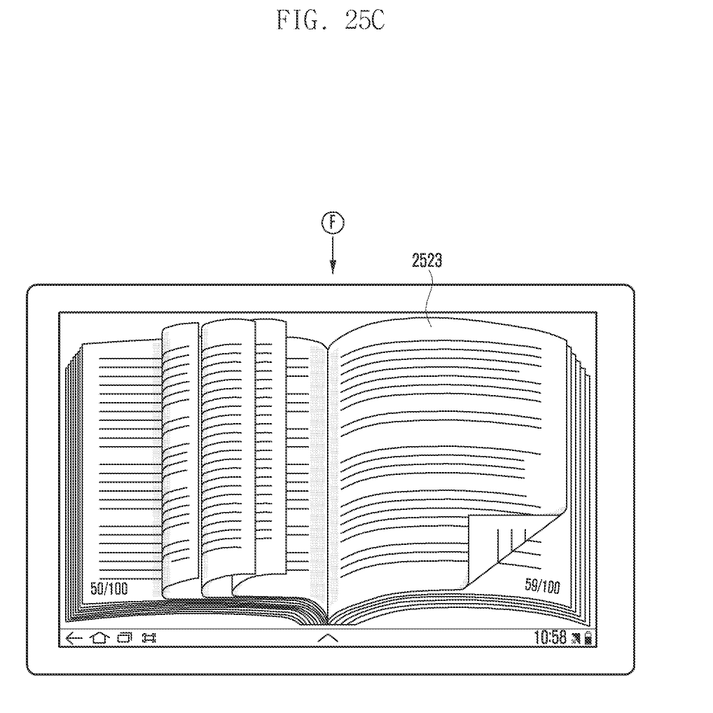

FIGS. 24A and 24B illustrate screens describing a method for stopping turning pages of an e-book according to an exemplary embodiment of the present invention. FIGS. 25A to 25C illustrate screens describing a method for stopping turning pages of an e-book according to an exemplary embodiment of the present invention.

Referring to FIGS. 24A and 24B, the controller 190 controls the display unit 112 to operate in a landscape mode in which one part 2410 and the other part 2420 of the pages of an e-book are displayed side by side. One part of the pages 2410 is located at the left portion of the screen and is called a first part. Likewise, the other part of the pages 2420 is located at the right portion of the screen and is called a second part. The first part 2410 is displayed together with a first volume area 2430 in the left edge 2411. The second part of pages 2420 is also displayed together with a second volume area 2440 in the right edge 2421.

Alternatively, the first part 2410 is also displayed with a first left area 2460. In that case, the first left area 2460 includes the first volume area 2430, and may further include a first margin 2450. The first margin area 2450 refers to an area created by a left margin width 2493 of the displayed page on the first part 2410, as shown in FIG. 24A. The left margin width 2493 may be preset (e.g., 1 cm). Likewise, the second part 2420 is also displayed with a second right area 2480. In that case, the second right area 2480 includes the second volume area 2440, and may further include a second margin 2470. The second margin area 2470 refers to an area created by a right margin width 2494 of the displayed page on the second part 2420. The right margin width 2494 may be preset. The left 2493 and right 2494 margin widths may be set to be equal to or differ from each other. For example, if the controller 190 detects the number of touches applied to the left (first) and right (second) part of the pages respectively and ascertains that the number of touches applied to the right part of pages is greater than that of the left part of the pages, the right margin width 2494 may be set to be greater than the left margin width 2493.

If the user applies a tap 2491 to the second right area 2480, the controller 190 expands the second right area 2490 and thus creates a second expanded volume area 2440′, as shown in FIG. 24B. In that case, the second expanded volume area 2440′ is greater in width than the second volume area 2440. In particular, during the process, as shown in FIG. 24B, the controller 190 protrudently displays the second part 2420 of the e-book on the display unit 112 to resemble pages of a paper book when the user holds and open such a paper book, thereby creating a second part of protrudently deformed pages 2420′. The second part 2420 may be protrudently deformed in the entire area or a preset area. For example, the second part 2420 may be protrudently deformed in the bottom edges. Alternatively, the second part 2420 may be protrudently deformed in such a way that the degree of protrudent deformation is the greatest in the bottom and gradually decreases in the top so that the top edges are not deformed. If the user applies a tap 2492 to the second expanded volume area 2440′ or a preset period of time (e.g., 3 seconds) has elapsed after the second expanded volume area 2440′ is created, the controller 190 restores the second expanded volume area 2440′ to the original state (i.e., the second volume area 2440).

Referring to FIGS. 25A to 25C, the controller 190 controls the display unit 112 to operate in a landscape mode where one part 2510 and the other part 2520 of the pages of an e-book are displayed side by side. One part of the pages 2510 is located at the left portion of the screen and is called a first part. Likewise, the other part of the pages 2520 is located at the right portion of the screen and is called a second part. The first part 2510 is displayed together with a first volume area 2530 in the left edge. The second part 2520 is also displayed together with a second volume area 2540 in the right edge. The controller 190 detects touch gestures (e.g., taps) on the volume areas 2530 and 2540. For example, if the controller 190 detects a tap on the second volume area 2540, the controller 190 protrudently deforms the second part 2520 and expands the second volume area 2540 as shown in FIG. 24A.

The controller 190 detects drag gestures on the volume areas 2530 and 2540. If the controller 190 detects a drag gesture on the second volume area 2540, moving outwards 2541 as shown in FIG. 25A, the controller 190 turns over pages one by one (or more than two) to the first part 2510, based on the detected drag gesture. For example, the controller 190 turns over the first page, and the next pages 2521 and 2522 of the second part 2520 as shown in FIG. 25B. If pages of the second part 2520 are rapidly turned over, the intervals between the fore edges of the pages vary in such a way that the interval α between the fore edge of the first page and the following page 2521 is larger than the interval β between the fore edge of the page 2521 and the following page 2522. The number of pages that are simultaneously turned over may be set according to a user's settings. The movement information regarding a touch gesture may include the speed of the touch gesture, the movement distance of the touch gesture, or the number of remaining pages. For example, the faster the touch gesture the faster the pages turn. The greater the movement distance of the touch gesture the faster the pages turn. The fewer the number of remaining pages the faster the pages turn. In addition, the movement information regarding a touch gesture may also include two or more of the speed of the touch gesture, the movement distance of the touch gesture, and the number of remaining pages. The shapes of pages turning vary according to a location in the volume area in which a touch is created, the speed and the movement direction of the touch gesture, and the like.

As described above, the controller 190 may turn over pages according to the aspects of motion of a touch in the volume area. If the controller 190 detects that a touch gesture is removed from the volume area, the controller 190 stops turning pages over. If the controller 190 detects user input information related to a page to be turned (e.g., a page indicated by reference number 2523 as shown in FIG. 25C), and detects that the page has a folded portion, the controller 190 may not respond to the touch motion 2542. For example, the controller 190 may not turn the page 2523 over. In addition to the visual feedback that would not turn the page over, the controller 190 may provide various types of feedback (e.g., an audio type of feedback such as sound effects, a haptic type of feedback such as vibration, and the like).

As described above, the system and method for displaying pages of e-book, according to exemplary embodiments of the present invention, can provide users who read e-books with the same feeling as reading a printed book when they are reading an e-book. The system and method allows users to fold over a corner of a page of an e-book as a bookmark as though the users fold over a corner of a page of a printed book.

As described above, the page display method according to exemplary embodiments of the present invention can be implemented with program commands that can be conducted via various types of computers and recorded in non-transitory computer-readable recording media. The non-transitory computer-readable recording media contain program commands, data files, data structures, or the like, or a combination thereof. The program commands recorded in the recording media may be designed or configured to comply with exemplary embodiments of the present invention or may be software well-known to the ordinary person skilled in the art. The computer-readable recoding media includes hardware systems for storing and conducting program commands. Examples of the hardware systems are magnetic media such as a hard disk, floppy disk, a magnetic tape, optical media such as CD-ROM and DVD, Magneto-Optical Media, such as floptical disk, ROM, RAM, flash memory, and the like. The program commands include assembly language or machine code complied by a complier and a higher level language interpreted by an interpreter. The hardware systems may be implemented with at least one software module to comply with exemplary embodiments of the present invention.

While the present invention has been described with reference to certain exemplary embodiments thereof, it will be understood by those skilled in the art that various changes in form and details may be made therein without departing from the spirit and scope of the invention as defined by the appended claims and their equivalents.

What is claimed is:

1. A page display method of a mobile device with a touch screen, the method comprising:
displaying at least one page of an e-book on the touch screen;
detecting a touch in a first corner area of one of the at least one displayed page;
deforming the first corner area to a second corner area in response to the touch;
detecting a first touch moving from the second corner area; and
folding the displayed page according to the movement of the first touch.

2. The method of claim 1, wherein the folding of the displayed page comprises:
folding the displayed page according to at least one of a movement direction, movement distance, and speed of the first touch.

3. The method of claim 2, further comprising:
detecting a second touch in a folded area of the displayed page, folded according to the movement of the first touch; and
deforming the folded area according to the movement of the second touch.

4. The method of claim 2, further comprising:
displaying at least one of a user's input information and a tag corresponding to the user's input information on the folded area of the displayed paged, folded according to the movement of the first touch.

5. The method of claim 1, wherein the deforming of the first corner area to a second corner area comprises one of the following:
deforming the first corner area as being lifted in response to the touch; and
displaying a visual cue in the first corner area.

6. The method of claim 1, wherein the displaying of the pages of the e-book comprises:
displaying a volume area in the edges of the pages; and
providing a visual type of feedback related to the folded page to the volume area.

7. The method of claim 1, wherein the folding of the displayed page comprises:
detecting that the first touch moves within a preset range of angle.

8. The method of claim 1, further comprising:
detecting a third touch in a folded area of the displayed page, folded according to the movement of the first touch; and
unfolding the folded area to the first corner area according to the movement of the third touch.

9. A page display method of a mobile device with a touch screen, the method comprising:
displaying at least one page of an e-book and a visual cue in at least one corner area of the displayed at least one page on the touch screen;
detecting a touch on the visual cue;
detecting a touch moving from the visual cue; and
deforming the displayed page according to the movement of the touch.

10. A page display method of a mobile device with a touch screen, the method comprising:
displaying at least one page of an e-book on the touch screen;
detecting a touch moving on the displayed at least one page;
determining whether the detected touch corresponds to a touch gesture for turning over the displayed page; and
turning at least one page over if the detected touch corresponds to a touch gesture for turning over the page, or folding the page if the detected touch does not correspond to a touch gesture for turning over the page.

11. The method of claim 10, wherein the determining of whether the detected touch corresponds to a touch gesture for turning over the displayed page comprises:
concluding that the page is not turned over, if a user's input information related to the page corresponds to information regarding the folded page.

12. A page turning method of a mobile device with a touch screen, the method comprising:
displaying at least one page of an e-book on the touch screen;
detecting a touch moving in an edge area of one of the displayed at least one page; and
turning pages over, in order, by a preset number, if the touch moves outwards from the edge area,
wherein turning pages over comprises:
stopping turning pages over if a page related to a user's input information is displayed.

13. The method of claim 12, wherein the turning of pages over comprises:
turning pages over until a folded page is displayed.

14. A mobile device comprising:
a touch screen for displaying at least one page of an e-book; and
a controller for controlling the touch screen,
wherein the controller is configured to detect a touch in a first corner area of one of the at least one displayed page, to deform the first corner area to a second corner area in response to the touch; to detect a first touch moving from the second corner area; and to fold the displayed page according to the movement of the first touch.

15. The mobile device of claim 14, wherein the controller is further configured to perform control operations so that one of the at least one displayed page is folded and displayed according to at least one of the movement direction, movement distance, and speed of the first touch.

16. The mobile device of claim 15, wherein the controller is further configured to detect a second touch in the folded area of one of the at least one displayed page, folded according to the movement of the first touch, and to deform the folded area according to the movement of the second touch.

17. The mobile device of claim 15, wherein the controller is configured to display a user's input information or a tag corresponding to the user's input information on the folded area of one of the at least one displayed paged, folded according to the movement of the first touch.

18. The mobile device of claim 14, wherein the controller is configured to deform the first corner area as being lifted in response to the touch or to display a visual cue in the first corner area.

19. The mobile device of claim 14, wherein the controller is configured to provide at least one of a haptic type of feedback and an audio type of feedback when deforming the first corner area to the second corner area.

20. A non-transitory computer-recordable medium, installed in a mobile device with a touch screen, on which a method for displaying at least one page is implemented, the method comprising:
displaying at least one page of an e-book on the touch screen;
detecting a touch in a first corner area of one of the at least one displayed page;
deforming the first corner area to a second corner area in response to the touch;
detecting a first touch moving from the second corner area; and
folding the displayed page according to the movement of the first touch.
